(19) United States
(12) Patent Application Publication
(10) Pub. No.: US 2025/0153227 A1
(43) Pub. Date: May 15, 2025

(54) WATER CLEANSING SYSTEM AND METHOD FOR WATER USAGE ENVIRONMENT

(71) Applicants: CAROMA INDUSTRIES LIMITED, North Sydney, New South Wales (AU); MICAS AG, Oelsnitz (DE)

(72) Inventor: Stephen John CUMMINGS, East Mona Vale, New South Wales (AU)

(73) Assignee: CAROMA INDUSTRIES LIMITED, Sydney, New South Wales (AU)

(21) Appl. No.: 18/838,418

(22) PCT Filed: Feb. 14, 2023
(86) PCT No.: PCT/AU2023/050098

§ 371 Date: Aug. 14, 2024

(30) Foreign Application Priority Data
Feb. 14, 2022 (AU) 2022900304

(51) Int. Cl. B08B 9/032

(52) U.S. Cl. CPC B08B 9/0325; B08B 2209/032

(57) ABSTRACT

A water cleansing system or method for a water usage environment, the system comprising: at least one water control device in the water usage environment, wherein the water control device is operable to operate in a water cleansing mode for cleansing the water control device and/or at least one water pipe connected to the water control device, at least one sensor for sensing whether it is safe to commence and/or continue the cleansing of the water control device and/or the pipework, and a control system arranged to control the water cleansing mode based on the sensing of the sensor.

### TECHNICAL FIELD

The present invention relates generally to a water cleansing system and method for water usage environments.

### BACKGROUND

Water usage environments in building facilities require regular maintenance for a number of different reasons. One reason is to reduce the risk of water becoming contaminated with bacteria due to a build-up of bacteria in warm or hot water systems as well as in stagnant cooler water. Examples of a water usage environment include a bathroom, a restroom, a toilet, a washroom or in general a “sanitary facility”. The water usage environment may be part of or connected to another room, such as a patient's room in a hospital or a cared person's room in a care facility. There may be multiple water usage environments located on a single floor of a building facility. There may also be multiple water usage environments located on multiple floors of a building facility

Building facilities may include hospitals, office buildings, hotels, motels, resorts, warehouse facilities, storage facilities, shopping malls, airports and the like. These types of building facilities may have a centralised Building Management System (BMS) that monitors and controls the water usage environments.

In general, water control devices are devices that are used in the water usage environment to provide water in a controlled manner using one or more operational parameters such as, for example, volume, flow rate, on/off timings etc. Water control devices may be connected to a water source to enable those devices to function as desired. These water control devices may be, for example, “end of line” plumbing fixtures such as tap ware, urinals, cisterns, showers, toilets, baths, bidets etc. The water control devices may also be water heater systems, water cooling towers etc.

The water control devices and associated and/or interconnected pipework may require maintenance, either periodically or in an ad-hoc manner, in order to reduce the risk of bacteria, such as Legionella, contaminating the water control device and/or interconnected pipework.

In addition to water control devices, the water usage environments also have other components for use by persons that are using the water usage environment. These components may include, for example, paper towel dispensers, soap dispensers, rubbish bins, hair and/or hand dryers, air fresheners, deodorisers, etc.

PCT publication WO2016/040989 by the present applicants entitled “Water Management System And Method” describes a system and method for controlling water control devices and is incorporated by reference herein in its entirety.

Problems may arise with existing systems in relation to the safety of persons using or intending to use the water usage environments when periodic and/or ad-hoc cleaning processes are operable to remove contaminated water from the water usage environments.

### SUMMARY

It is an object of the present invention to substantially overcome, or at least ameliorate, one or more disadvantages of existing arrangements.

Disclosed are arrangements which seek to address the problems associated with the operation and timing of periodic and/or ad-hoc water cleaning processes in relation to water usage environments and contaminated water associated with water control devices and/or associated pipework.

According to a first aspect of the present disclosure, there is provided a water cleansing system for a water usage environment, the system comprising: at least one water control device in the water usage environment, wherein the water control device is operable to operate in a water cleansing mode for cleansing the water control device and/or at least a portion of pipework connected to the water control device, at least one sensor for sensing whether it is safe to commence and/or continue the cleansing of the water control device and/or the pipework, and a control system arranged to control the water cleansing mode based on the sensing of the sensor.

The water cleansing system may be a thermal cleansing system, and the water cleansing mode may be a thermal cleansing mode for thermally cleansing the water control device and/or the portion of pipework connected to the water control device, and the control system may be arranged to control the thermal cleansing mode based on the sensing of the sensor. The thermal cleansing mode may enable a thermal mixer valve to operate at a defined water temperature for a defined period of time to enable hot water to flow through the water control device and/or the portion of pipework via the thermal mixer valve.

The water cleansing system may be a standing water cleansing system, the water cleansing mode may be a standing water cleansing mode for cleansing standing water from the water control device and/or the portion of pipework connected to the water control device, and the control system may be arranged to control the standing water cleansing mode based on the sensing of the sensor. The standing water cleansing mode may enable the water control device to operate at a defined water temperature for a defined period of time to enable cold water to flow through the water control device and/or the portion of pipework.

The at least one sensor may sense whether at least one person is entering, within, in proximity to or exiting the water usage environment, to generate an occupancy signal for use by the control system, wherein the control system is arranged to control the water cleansing mode based on the occupancy signal. The occupancy signal may indicate current occupancy of the water usage environment by the person, potential future occupancy of the water usage environment by the person or non-occupancy of the water usage environment.

The control system may determine whether it is safe to activate the water cleansing mode based on the sensing by the sensor and, upon a positive determination, enables the water cleansing mode to be activated. The control system may activate the water cleansing mode upon receiving an activation signal. The control system may enable the water cleansing mode to be activated by generating and outputting an indication indicating that it is safe to activate the water cleansing mode. The indication may be an operable button that is displayed that, upon operating, generates an activation signal to cause the control system to activate the water cleansing mode. The indication may be at least one of a visual, audible, haptic indication, display of a message, symbol, colour, sound, vibration etc.

A computer associated with the control system, such as a computer or processor associated with a gateway, server, BMS or Facility management system, may determine whether it is safe to activate the water cleansing mode based on the sensing by the sensor and, upon a positive determination, activate the water cleansing mode.

The sensor may be for sensing at least one person approaching, entering, being within or exiting the water usage environment.

The sensor may be a door movement sensor, a person movement sensor, a water control device person sensor, a gateway sensor, a tap sensor, a toilet flush sensor, a shower sensor, a soap dispensing sensor, a bin usage sensor, a paper towel dispenser sensor. The sensor may be incorporated into, in communication with, or integrated with the water control device.

The sensor may be a sensor that operates in a low-sense mode to detect the person to activate the water control device, and operates in a high-sense mode to detect the person is nearby to the sensor without activating the water control device.

The water cleansing system may comprise a plurality of the water control device, each water control device having the sensor incorporated therein, wherein each water control device may be connected via a wireless network, wherein the control system may be arranged to control the water cleansing mode of any one water control device based on the sensing of the sensor associated with any one water control device.

The water cleansing system may comprise a plurality of the water control device, each water control device having the sensor incorporated therein, wherein each water control device may be connected via a wireless network, wherein the control system may be arranged to control the water cleansing mode of any one water control device based on the sensing of the sensor associated with any one other device in the water usage environment.

The system may comprise at least one further sensor arranged to detect a credential associated with at least one authorised person, and generate an authorisation signal based on the credential, wherein the control system is arranged to control the water cleansing mode based on the authorisation signal. The control system may modify the water cleansing mode upon a determination that the authorised person, e.g. manager, cleaner and/or service person, has a credential that permits the water cleansing mode to be modified. The water cleansing mode may be modified by allowing the water cleansing mode to continue in the event that the authorised person, e.g. the manager, cleaner and/or service person, approaches and/or enters the water usage environment.

Upon activation of the water cleansing mode by the control system, the control system may be further arranged to deactivate the water cleansing mode upon a determination that at least one person is within, approaching and/or entering the water usage environment based on the sensing of the sensor. Wherein deactivating the water cleansing mode may comprise one or more of the control system: stopping hot water from flowing through the water control device and/or the pipework; stopping hot water from flowing in the water usage environment; diverting hot water flowing out of a water control device to an auxiliary water outlet; stopping a water control device from functioning; generating an audible or visible indication that a water control device is not to be used; generating an indication that a water control device is out of service; causing cold water to flow through the water control device to cool the water control device down.

According to a second aspect of the present disclosure, there is provided a water cleansing method for a water usage environment comprising at least one water control device in a water usage environment that is operable in a water cleansing mode for cleansing the water control device and/or at least a portion of pipework connected to the water control device, the method comprising the steps of: sensing, with at least one sensor, whether it is safe to commence and/or continue the cleansing of the water control device and/or the pipework, and controlling, with a control system, the water cleansing mode based on the sensing of the sensor.

The water cleansing mode may be a thermal cleansing mode for thermally cleansing the water control device and/or the portion of pipework connected to the water control device, and the method may comprise the step of controlling the thermal cleansing mode based on the sensing of the sensor.

The method may further comprise the step of operating a thermal mixer valve at a defined water temperature for a defined period of time to enable hot water to flow through the water control device and/or the portion of pipework via the thermal mixer valve.

The water cleansing mode may be a standing water cleansing mode for cleansing standing water from the water control device and/or the portion of pipework connected to the water control device, and the method may comprise the step of controlling the standing water cleansing mode based on the sensing of the sensor.

The method may further comprise the step of operating the water control device at a defined water temperature for a defined period of time to enable cold water to flow through the water control device and/or the portion of pipework.

The method may further comprise the step of sensing whether at least one person is entering, within, in proximity to or exiting the water usage environment, to generate an occupancy signal for use by the control system, and controlling the water cleansing mode based on the occupancy signal.

The occupancy signal may indicate current occupancy of the water usage environment by the person, potential future occupancy of the water usage environment by the person or non-occupancy of the water usage environment.

The method may further comprise the steps of determining whether it is safe to activate the water cleansing mode based on the sensing by the sensor and, upon a positive determination, enabling the water cleansing mode to be activated.

The method may further comprise the steps of enabling the water cleansing mode to be activated by generating and outputting an indication indicating that it is safe to activate the water cleansing mode.

The method may further comprise the steps of outputting an operable button as the indication, and generating an activation signal to activate the water cleansing mode upon operation of the button.

The method may further comprise the steps of determining whether it is safe to activate the water cleansing mode based on the sensing by the sensor and, upon a positive determination, activating the water cleansing mode.

The method may further comprise the step of sensing at least one person approaching, entering, being within or exiting the water usage environment.

The method may further comprise the steps of operating the sensor in a low-sense mode to detect the person to activate the water control device, and operating the sensor in a high-sense mode to detect the person is nearby to the sensor without activating the water control device.

The method may further comprise the step of controlling the water cleansing mode of any one water control device based on the sensing of the sensor associated with any one other water control device.

The method may further comprise the step of controlling the water cleansing mode of any one water control device based on the sensing of the sensor associated with any one other device in the water usage environment.

The method may further comprise the steps of detecting, using a sensor, a credential associated with at least one authorised person, generating an authorisation signal based on the credential, and controlling the water cleansing mode based on the authorisation signal.

The method may further comprise the step of modifying the water cleansing mode upon a determination that the authorised person has a credential that permits the water cleansing mode to be modified.

The method may further comprise the steps of modifying the water cleansing mode by allowing the water cleansing mode to continue in the event the authorised person approaches and/or enters the water usage environment.

Upon activation of the water cleansing mode, the method may further comprise the steps of deactivating the water cleansing mode upon a determination that at least one person is within, approaching and/or entering the water usage environment based on the sensing of the sensor. Deactivating the water cleansing mode may comprise one or more of: stopping hot water from flowing through the water control device and/or the pipework; stopping hot water from flowing in the water usage environment; diverting hot water flowing out of a water control device to an auxiliary water outlet; stopping a water control device from functioning; generating an audible or visible indication that a water control device is not to be used; generating an indication that a water control device is out of service; causing cold water to flow through the water control device to cool the water control device down.

Other aspects are also disclosed.

### BRIEF DESCRIPTION OF THE DRAWINGS

At least one embodiment of the present invention will now be described with reference to the drawings and appendices, in which:

FIGS. 1A and 1B form a schematic block diagram of a general-purpose computer system upon which arrangements described can be practiced;

FIGS. 2A and 2B collectively form a schematic block diagram representation of an embedded electronic device upon which described arrangements can be practised;

FIGS. 3A to 3F show example network configurations upon which describe arrangements can be practised;

FIG. 4 shows an example system schematic diagram in accordance with a described embodiment;

FIG. 5 shows a process flow diagram according to an example of operation of a water cleansing system and method in accordance with a described embodiment;

FIG. 6A shows an example of a water usage environment in accordance with a described embodiment;

FIG. 6B shows an example of a water control device and sensor in accordance with a described embodiment;

FIG. 6C shows a further example of a water usage environment in accordance with a described embodiment;

FIGS. 7A and 7B show an example of flush unit operating in a high sense mode in accordance with a described embodiment;

FIG. 8 shows an example of a thermo mixer valve operation in accordance with a described embodiment;

FIGS. 9A to 9D depict various scenarios in a water usage environment in accordance with described embodiments;

FIG. 10 shows an example water control device in accordance with described embodiments;

FIG. 11 shows an example of a controller of a water control device in accordance with described embodiments.

### DETAILED DESCRIPTION INCLUDING BEST MODE

A water cleansing system for a water usage environment is now described along with an associated method. The water control device is operable to operate in a water cleansing mode for cleansing the water control device and/or at least a portion of pipework (e.g. a water or waste pipe) connected to the water control device. At least one sensor is provided for sensing whether it is safe to commence and/or continue the cleansing of the water control device and/or the pipework. A control system is arranged to control the water cleansing mode based on the sensing of the sensor.

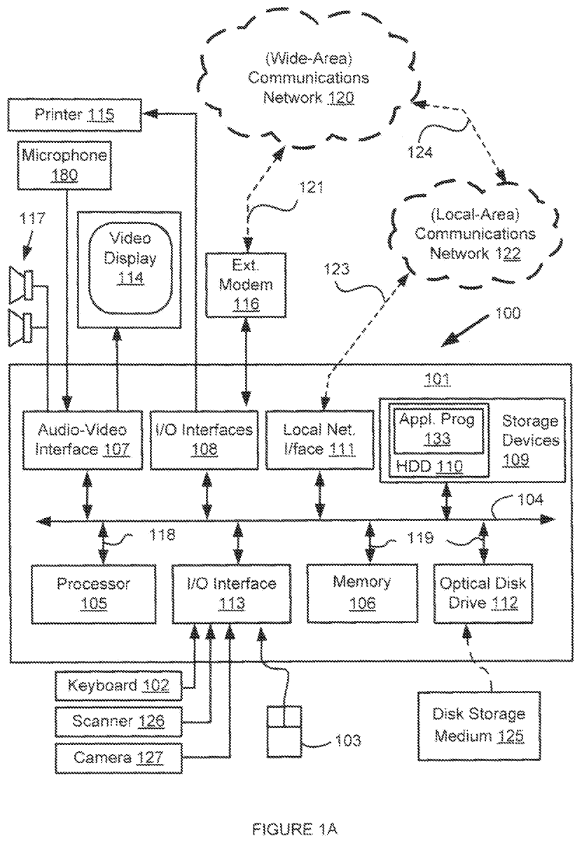

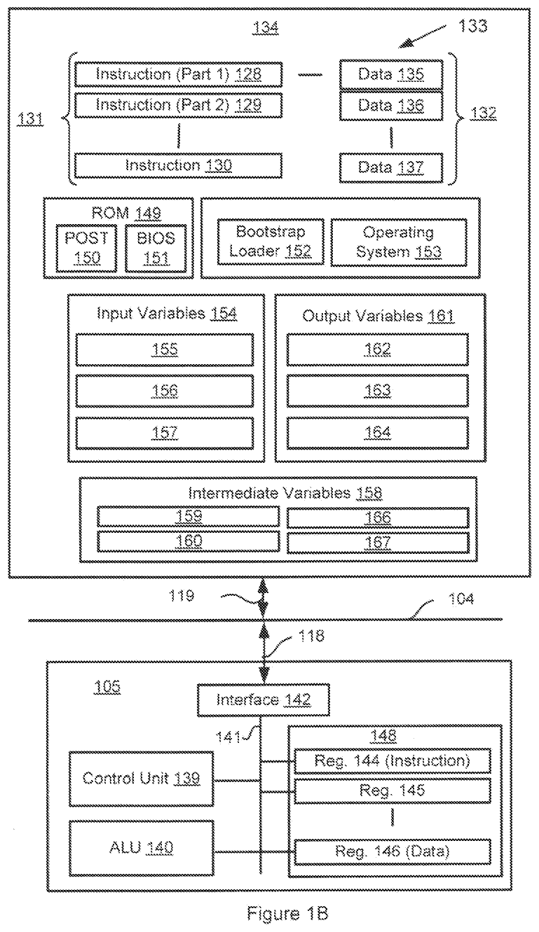

FIGS. 1A and 1B depict a general-purpose computer system 100, upon which various arrangements described herein may be practiced. For example, the computer system may be used to form any number of different computing, processing and/or control systems in the herein described water cleansing system and method.

As seen in FIG. 1A, the typical computer system 100 includes: a computer module 101; input devices such as a keyboard 102, a mouse pointer device 103, a scanner 126, a camera 127, and a microphone 180; and output devices including a printer 115, a display device 114, loudspeakers 117 and haptic outputs (e.g. a vibrating component). The display device 114 maybe a touchscreen display. Further, one or more water control devices as described herein may be connected via the I/O Interface 113. Further, one or more electronic devices as described herein may be connected via the I/O Interface 113. Further, a building management system may be connected via the I/O Interface 113. Further, one or more intermediate processing devices may be connected via the I/O interface 113. Further an external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick, touchscreen, voice recognition system or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth© wireless arrangement or an IEEE 802.11 wireless arrangement; however, numerous other types of interfaces may be practiced for the interface 111.

The local communications network 122 and/or the wide area communications network 120 may communicate with one or more controllers of water control devices as described herein. Further, the local communications network 122 and/or the wide area communications network 120 may communicate with other computing systems 100, electronic devices 201 (described below), Building Management Systems (BMS) etc.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the computer system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118. Likewise, the memory 106 and optical disk drive 112 are coupled to the system bus 104 by connections 119. Examples of computers on which the described arrangements can be practised include IBM-PC's and compatibles, Apple Mac™ or a like computer systems.

The herein described computer may be, for example, configured as a server connected to the Internet and arranged to receive data in the form of instructions and information from other computers, electronic devices and water control devices connected to the server via the Internet. For example, the server may be connected to a local area network (LAN) or a wide area network (WAN). Access to the server may be by direct connection via the Internet or via other networks, such as LANs and WANs. The server may be configured to perform one or more of the various methods described herein in relation to the water cleansing system and method.

The herein described computer may be, for example, a building management computer forming part of a building management system (BMS) for controlling operations of a building. The building management system may form part of or be in communication with the building facility water management system described herein. The building management computer may communicate with the building management system, the building facility water management system and their components using any suitable communication protocols. The building management computer may be configured to perform one or more functions in relation to the water cleansing system and method.

The building management system (BMS) may use standard BMS protocols such as BACnet, LON etc to communicate with other devices or components in the building facility water management system.

The herein described computer may be, for example, a personal computer or laptop forming part of a building management system for controlling operations of a building. The building management system may form part of or be in communication with the building facility water management system described herein. The personal computer or laptop may communicate with the building management system, the building facility water management system and their components using any suitable communication protocols. The personal computer or laptop may be configured to perform one or more functions in relation to the water cleansing system and method.

One or more of the methods as described herein may be implemented using the computer system 100 wherein the processes described herein, may be implemented as one or more software application programs (“software”) 133 executable within the computer system 100. For example, the steps of these processes may be effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the herein described methods and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the software in the computer system 100 preferably effects an advantageous apparatus or system for the described water cleansing system and method. Further, the software may also be used to implement an artificial intelligence (AI) and/or machine learning (ML) system to be used in or to perform the water cleansing system and method.

The software 133 is typically stored in the HDD 110 or the memory 106. The software is loaded into the computer system 100 from a computer readable medium and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for managing water cleansing safety.

In some instances, the software 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on websites and the like.

The second part of the software 133 and the corresponding code modules mentioned above may be executed to implement one or more graphical user interfaces (GUls) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The software 133 includes a sequence of instructions 131 that may include conditional branch and loop instructions. The software 133 may also include data 132 which is used in execution of the software 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 1105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed water cleansing system and method use input variables 154, which are stored in the memory 134 in corresponding memory locations 155, 156, 157. The water cleansing system and method produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the software 133. Each fetch, decode, and execute cycle comprises:
a fetch operation, which fetches or reads an instruction 131 from a memory location 128, 129, 130;
a decode operation in which the control unit 139 determines which instruction has been fetched; and
an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes described herein may be associated with one or more segments of the software 133 and is performed by the register section 144, 145, 147, the ALU 140, and the control unit 139 in the processor 105 working together to perform the fetch, decode, and execute cycles for every instruction in the instruction set for the noted segments of the software 133.

The system or method of water cleansing safety may alternatively be implemented in dedicated hardware such as one or more integrated circuits performing the functions or sub functions of a water cleansing system or method. Such dedicated hardware may include graphic processors, digital signal processors, or one or more microprocessors and associated memories.

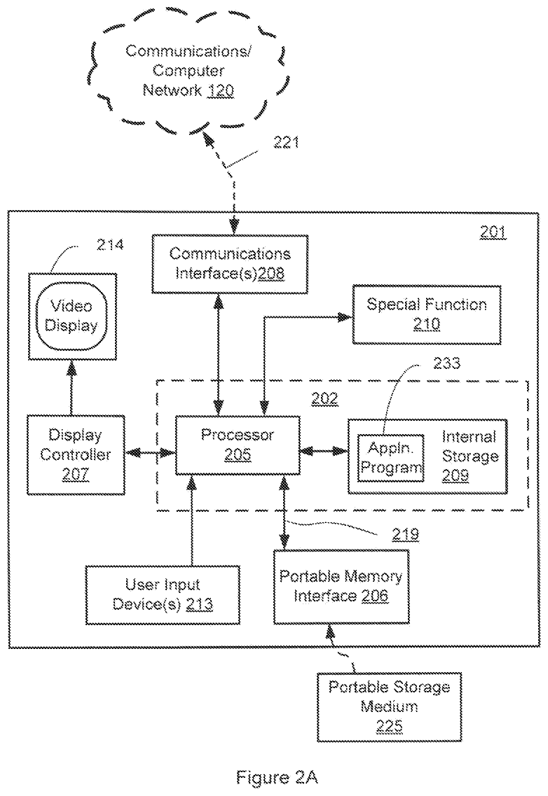

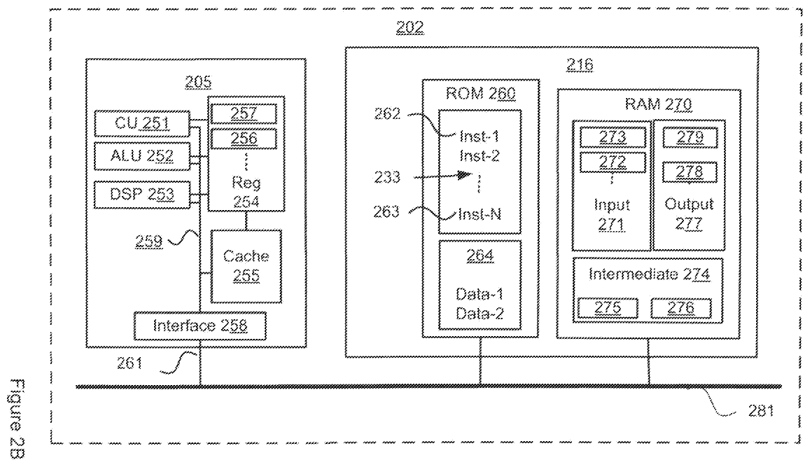

FIGS. 2A and 2B collectively form a schematic block diagram of a general-purpose electronic device 201 including embedded components, upon which the water cleansing system and method described herein are practiced. The embedded electronic device 201 may be, for example, a mobile phone, a tablet device, a smart watch, personal digital assistant type device or any other embedded electronic device, in which processing resources may be limited. Nevertheless, the methods described herein may also be performed on higher-level devices such as desktop computers, server computers, and other such devices with significantly larger processing resources. For example, the electronic device may be used to form any number of different computing, processing and/or control systems in the herein described water cleansing system and method.

As seen in FIG. 2A, the electronic device 201 comprises an embedded controller 202. Accordingly, the electronic device 201 may be referred to as an “embedded device.” In the present example, the controller 202 has a processing unit (or processor) 205 which is bi-directionally coupled to an internal storage module 209. The storage module 209 may be formed from non-volatile semiconductor read only memory (ROM) 260 and semiconductor random access memory (RAM) 270, as seen in FIG. 2B. The RAM 270 may be volatile, non-volatile or a combination of volatile and non-volatile memory.

The electronic device 201 includes a display controller 207, which is connected to a video display 214, such as a liquid crystal display (LCD) panel or the like. The display controller 207 is configured for displaying graphical images on the video display 214 in accordance with instructions received from the embedded controller 202, to which the display controller 207 is connected.

The electronic device 201 also includes user input devices 213 which are typically formed by keys, a keypad or like controls. In some implementations, the user input devices 213 may include a touch sensitive panel physically associated with the display 214 to collectively form a touchscreen. Such a touchscreen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 2A, the electronic device 201 also comprises a portable memory interface 206, which is coupled to the processor 205 via a connection 219. The portable memory interface 206 allows a complementary portable memory device 225 to be coupled to the electronic device 201 to act as a source or destination of data or to supplement the internal storage module 209. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 201 also has a communications interface 208 to permit coupling of the device 201 to a computer or communications network 220 via a connection 221. For example, one or more water control devices as described herein may be connected to the electronic device via the communications interface 208. Further, one or more electronic devices as described herein may be connected to the electronic device via the communications interface 208. Further, a building management system may be connected to the electronic device via the communications interface 208. Further, one or more water control devices as described herein may be connected to the electronic device via the communications interface 208. Further, one or more intermediate processing devices may be connected to the electronic device via the communications interface 208.

The connection 221 may be wired or wireless. For example, the connection 221 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like. The electronic device 201 may communicate with one or more water control devices.

Typically, the electronic device 201 is configured to perform some special function. The embedded controller 202, possibly in conjunction with further special function components 210, is provided to perform that special function. The special function components 210 are connected to the embedded controller 202. As an example, the device 201 may be a mobile telephone handset. In this instance, the components 210 may represent those components required for communications in a cellular telephone environment. Alternatively, the components 210 may be an artificial intelligence (AI) and/or machine learning (ML) module used in or for performing the water cleansing system or method as described herein.

Various methods associated with water safety system described hereinafter may be implemented using the embedded controller 202, where the processes described herein may be implemented as one or more software application programs (“software”) 233 executable within the embedded controller 202. The electronic device 201 of FIG. 2A implements the described methods. In particular, with reference to FIG. 2B, the steps of the herein described methods are effected by instructions in the software 233 that are carried out within the controller 202. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user. Further, the software 233 may be used to implement an artificial intelligence (AI) and/or machine learning (ML) system used in or to perform the water cleansing system and method as described herein.

The software 233 of the embedded controller 202 is typically stored in the non-volatile ROM 260 of the internal storage module 209. The software 233 stored in the ROM 260 can be updated when required from a computer readable medium. The software 233 can be loaded into and executed by the processor 205. In some instances, the processor 205 may execute software instructions that are located in RAM 270. Software instructions may be loaded into the RAM 270 by the processor 205 initiating a copy of one or more code modules from ROM 260 into RAM 270. Alternatively, the software instructions of one or more code modules may be pre-installed in a non-volatile region of RAM 270 by a manufacturer. After one or more code modules have been located in RAM 270, the processor 205 may execute software instructions of the one or more code modules.

The software 233 is typically pre-installed and stored in the ROM 260 by a manufacturer, prior to distribution of the electronic device 201. However, in some instances, the software 233 may be supplied to the user encoded on one or more CD-ROM (not shown) and read via the portable memory interface 206 of FIG. 2A prior to storage in the internal storage module 209 or in the portable memory 225. In another alternative, the software 233 may be read by the processor 205 from the network 220, or loaded into the controller 202 or the portable storage medium 225 from other computer readable media. Computer readable storage media refers to any non-transitory tangible storage medium that participates in providing instructions and/or data to the controller 202 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 201. Examples of transitory or non-tangible computer readable transmission media that may also participate in the provision of software, application programs, instructions and/or data to the device 201 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the software 233 and the corresponding code modules mentioned above may be executed to implement one or more graphical user interfaces (GUls) to be rendered or otherwise represented upon the display 214 of FIG. 2A. Through manipulation of the user input device 213 (e.g., the keypad), a user of the device 201 and the software 233 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 2B illustrates in detail the embedded controller 202 having the processor 205 for executing the software 233 and the internal storage 209. The internal storage 209 comprises read only memory (ROM) 260 and random access memory (RAM) 270. The processor 205 is able to execute the software 233 stored in one or both of the connected memories 260 and 270. When the electronic device 201 is initially powered up, a system program resident in the ROM 260 is executed. The software 233 permanently stored in the ROM 260 is sometimes referred to as “firmware”. Execution of the firmware by the processor 205 may fulfil various functions, including processor management, memory management, device management, storage management and user interface.

The processor 205 typically includes a number of functional modules including a control unit (CU) 251, an arithmetic logic unit (ALU) 252, a digital signal processor (DSP) 2153 and a local or internal memory comprising a set of registers 254 which typically contain atomic data elements 256, 257, along with internal buffer or cache memory 255. One or more internal buses 259 interconnect these functional modules. The processor 205 typically also has one or more interfaces 258 for communicating with external devices via system bus 281, using a connection 261.

The software 233 includes a sequence of instructions 262 through 263 that may include conditional branch and loop instructions. The software 233 may also include data, which is used in execution of the software 233. This data may be stored as part of the instruction or in a separate location 264 within the ROM 260 or RAM 270.

In general, the processor 205 is given a set of instructions, which are executed therein. This set of instructions may be organised into blocks, which perform specific tasks or handle specific events that occur in the electronic device 201. Typically, the software 233 waits for events and subsequently executes the block of code associated with that event. Events may be triggered in response to input from a user, via the user input devices 213 of FIG. 2A, as detected by the processor 205. Events may also be triggered in response to other sensors and interfaces in the electronic device 201.

The execution of a set of the instructions may require numeric variables to be read and modified. Such numeric variables are stored in the RAM 270. The disclosed method uses input variables 271 that are stored in known locations 272, 273 in the memory 270. The input variables 271 are processed to produce output variables 277 that are stored in known locations 278, 279 in the memory 270. Intermediate variables 274 may be stored in additional memory locations in locations 275, 276 of the memory 270. Alternatively, some intermediate variables may only exist in the registers 254 of the processor 205.

The execution of a sequence of instructions is achieved in the processor 205 by repeated application of a fetch-execute cycle. The control unit 251 of the processor 205 maintains a register called the program counter, which contains the address in ROM 260 or RAM 270 of the next instruction to be executed. At the start of the fetch execute cycle, the contents of the memory address indexed by the program counter is loaded into the control unit 251. The instruction thus loaded controls the subsequent operation of the processor 205, causing for example, data to be loaded from ROM memory 260 into processor registers 254, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the software 233, and is performed by repeated execution of a fetch-execute cycle in the processor 205 or similar programmatic operation of other independent processor blocks in the electronic device 201.

Various examples of water control device configuration, operation and control will now be described in relation to the herein described water cleansing system and method.

It will be understood that where examples are described in which a particular type of water control device is operated that other alternative types of water control device may also be operated in a similar manner.

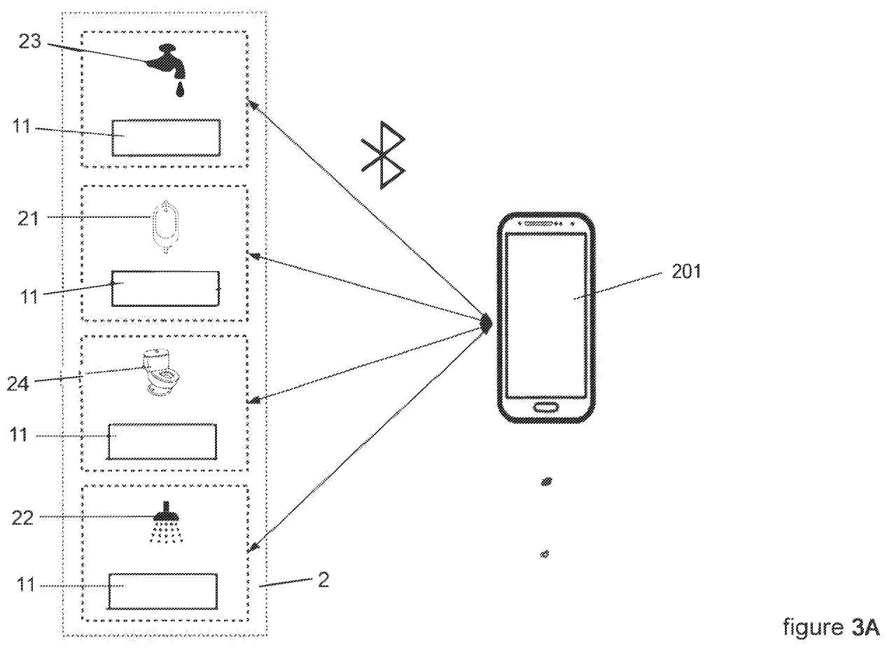

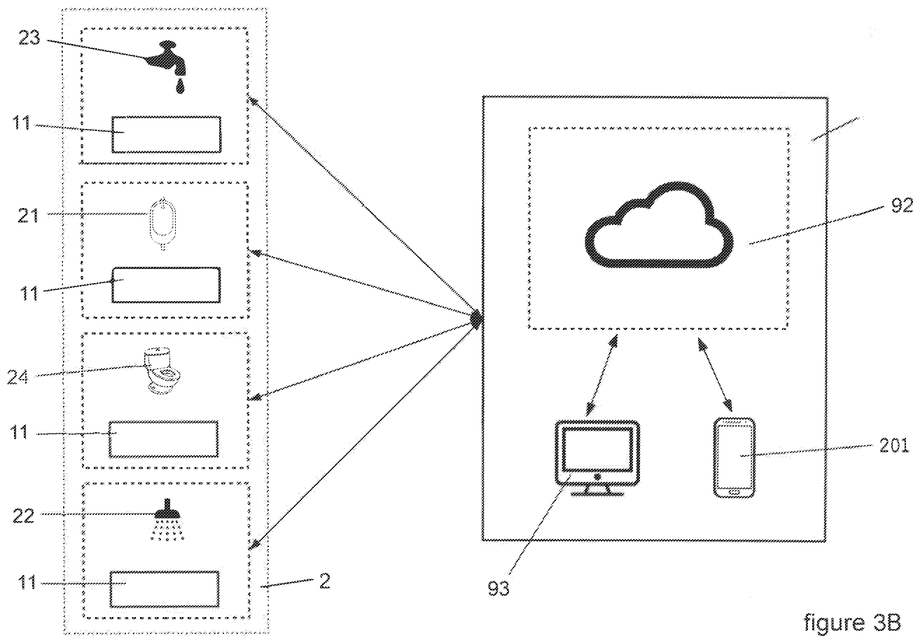

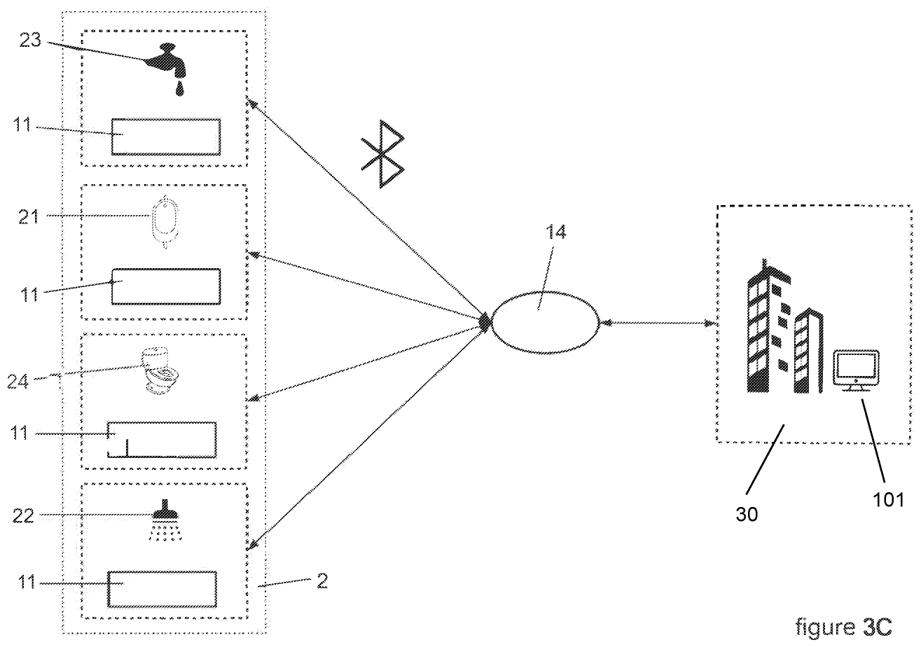

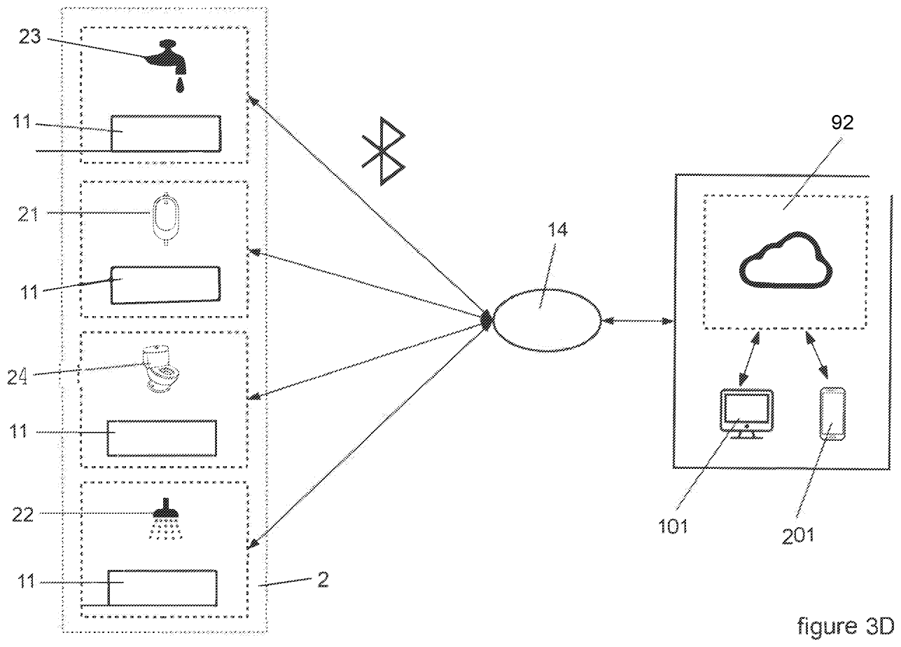

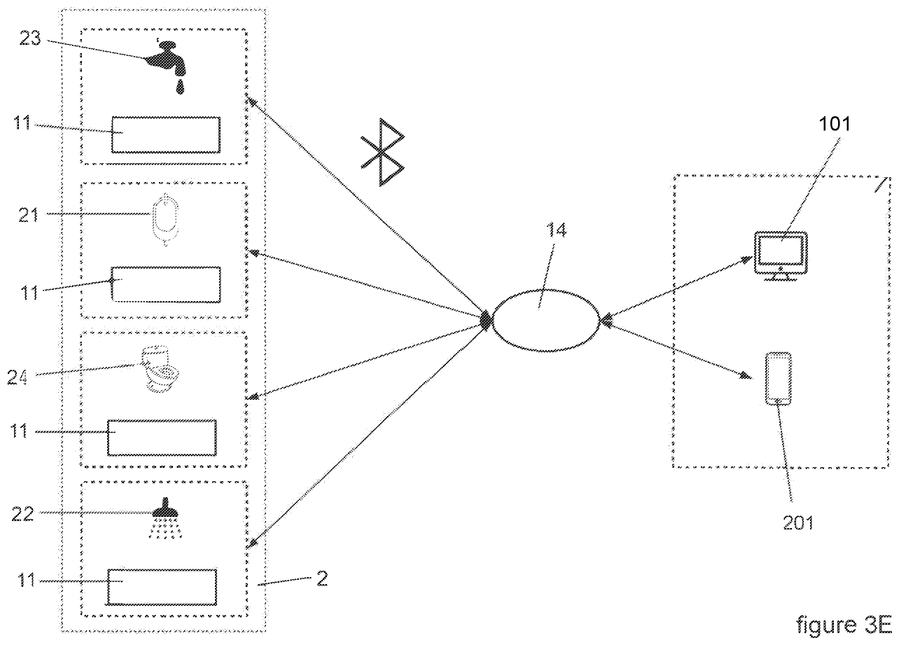

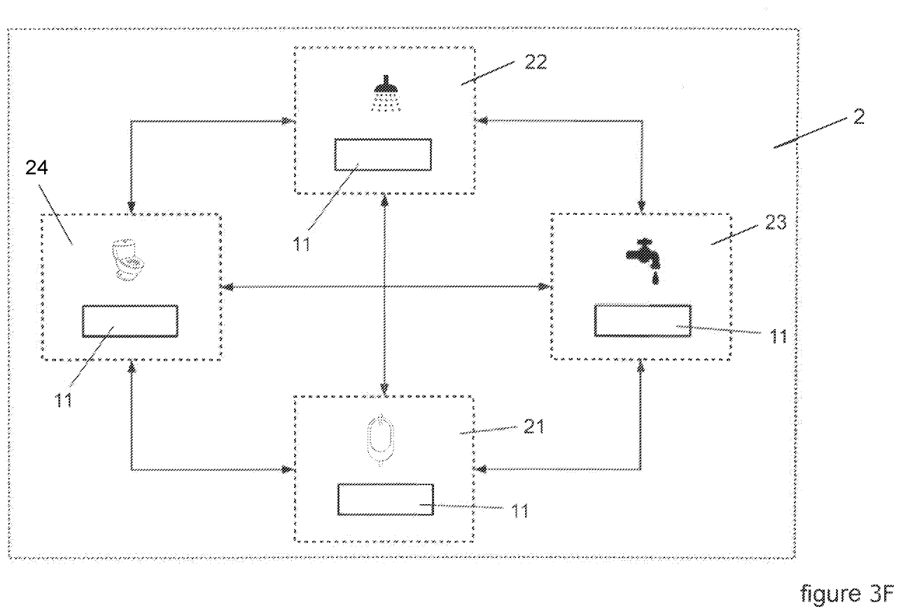

FIGS. 3A to 3F show several different example network configurations of water control devices, connected devices and computers in which the herein described methods may be applied.

In FIG. 3A, water control devices are shown in a sanitary facility 2 (e.g. water usage environment). The water control devices include, for example, a urinal 21, a shower 22, a tap (or faucet) 23 and a toilet 24. Each of the water control devices has an associated water control device controller 11. The controller 11 of each water control device can communicate using Bluetooth to an electronic device 201, as described above with reference to FIGS. 2A & 2B. For example, the electronic device may be a mobile telephone handset, tablet device or other small computing device. It will also be understood that each controller of a water control device may communicate separately with multiple electronic devices as indicated by the dots in FIG. 3A.

It will be understood that alternative communication means other than Bluetooth may be used such as IrDA (Infrared data association protocol), local Wi-Fi communications etc.

FIG. 3A shows a network configuration in which each controller of a water control device communicates separately via an Internet server 92 to a computing device 100 as described above with reference to FIGS. 1A & 1B and/or an electronic device 201 as described above with reference to FIGS. 2A & 2B. It will be understood that the Internet server 92 may be formed using a suitably programmed computing device as described with reference to FIGS. 1A and 1B.

For example, the electronic device 201 may be a mobile telephone handset, tablet device or other small computing device. Also, for example, the computing device 100 may be a personal computer, a laptop, a server, a building management system computer etc.

In FIG. 3B, water control devices are shown in a sanitary facility 2 (e.g. water usage environment). The water control devices include, for example, a urinal 21, a shower 22, a tap (or faucet) 23 and a toilet 24. Each of the water control devices has an associated water control device controller 11. The controller 11 of each water control device can communicate using any suitable Internet connection such as via a Wi-Fi modem, or a cellular data connection, such as 4G or 5G. An intermediate processing device (not shown) may be provided such as a central gateway device, modem and/or router to enable one or more of the water control devices to communicate with the Internet.

It will be understood that intermediate communication protocols may be used such as Bluetooth and IrDA (Infrared data association protocol) etc. to enable the Internet connection.

FIG. 3B shows a network configuration in which each controller of a water control device communicates separately to the computing device 100 and/or the electronic device 201. It will also be understood that each controller of a water control device may communicate separately with multiple computing devices and/or multiple electronic devices.

For example, the electronic device 201 may be a mobile telephone handset, tablet device or other small computing device. Also, for example, the computing device 100 may be a personal computer, a laptop, a server, a building management system computer etc.

In FIG. 3C, water control devices are shown in a sanitary facility 2 (e.g. water usage environment). The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, to enable one or more of the water control devices to communicate via the intermediate processing device to a Building Management System (BMS) 30. For example, the central gateway device may communicate directly with the BMS using standard BMS protocols such as BACnet, LON etc to communicate. The BMS may include one or more computing devices 100 and/or electronic devices (not shown) to enable the BMS to communicate with the water control devices via the intermediate processing device 14.

The intermediate processing device 14 may be a router that communicates via a server (e.g. a suitably programmed computing device as described with reference to FIGS. 1A and 1B) that then forms part of, or communicates with, the BMS.

For example, the electronic device 201 may be a mobile telephone handset, tablet device or other small computing device. Also, for example, the computing device 100 may be a personal computer, a laptop, a server, a building management system computer etc.

It will be understood that alternative communication means other than Bluetooth may be used such as IrDA (Infrared data association protocol), local Wi-Fi communications etc.to enable the water control devices to communicate with the BMS, and vice versa.

FIG. 3C shows a network configuration in which each controller of a water control device communicates separately via a single intermediate processing device to the BMS. It will also be understood that each controller of a water control device may communicate separately with its own intermediate processing device.

In FIG. 3D, water control devices are shown in a sanitary facility 2 (e.g. water usage environment). The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, a modem and/or router to enable one or more of the water control devices to communicate via the intermediate processing device to a Building Management System (BMS) 30. In this configuration, the intermediate processing device communicates with the BMS via the Internet. The BMS may include one or more computing devices 100 and/or electronic devices (not shown) to enable the BMS to communicate with the water control devices via the intermediate processing device.

For example, the electronic device 201 may be a mobile telephone handset, tablet device or other small computing device. Also, for example, the computing device 100 may be a personal computer, a laptop, a server, a building management system computer etc.

It will be understood that alternative communication means other than Bluetooth may be used such as IrDA (Infrared data association protocol), local Wi-Fi communications etc.to enable the water control devices to communicate with the BMS, and vice versa.

FIG. 3D shows a network configuration in which each controller of a water control device communicates separately via a single intermediate processing device to the BMS. It will also be understood that each controller of a water control device may communicate separately with its own intermediate processing device.

In FIG. 3E, water control devices are shown in a sanitary facility 2 (e.g. water usage environment). The water control devices include, for example, a urinal 21, a shower 22, a tap (or faucet) 23 and a toilet 24. The controller 11 of each water control device can communicate using Bluetooth to an intermediate processing device 14. The intermediate processing device may be, for example, a central gateway device, to enable one or more of the water control devices to communicate via the intermediate processing device to one or more computing devices 100 and/or electronic devices 201.

The intermediate processing device 14 may be a router that communicates via a server (e.g. a suitably programmed computing device as described with reference to FIGS. 1A and 1B) that then forms part of, or communicates with, the one or more computing devices 100 and/or electronic devices 201.

For example, the electronic device 201 may be a mobile telephone handset, tablet device or other small computing device. Also, for example, the computing device 100 may be a personal computer, a laptop, a server, a building management system computer etc.

It will be understood that alternative communication means other than Bluetooth may be used such as IrDA (Infrared data association protocol), local Wi-Fi communications etc.to enable the water control devices to communicate with the intermediate processing device.

It will be understood that any suitable communication protocols may be used to enable the intermediate processing device to communicate with the one or more computing devices 100 and/or electronic devices 201, such as IrDA (Infrared data association protocol, Bluetooth, Wi-Fi, cellular data etc.

FIG. 3F shows a network configuration in which each controller 11 of a water control device communicates with other controllers 11 in other water control devices. The network is configured as a mesh network. In this example configuration, data may be shared between water control devices in the mesh network. A first controller in a first water control device may be enabled to control/monitor the first water control device. Alternatively, the first controller in the first water control device may be enabled to control/monitor one or more other water control devices based on data received from one or more other controllers. Also, a controller in a first water control device may be enabled to control/monitor the first water control device and/or one or more other water control devices. Further, data received at a first controller from a first water control device may be used to control/monitor the first water control device and/or one or more other water control devices.

In FIG. 3F, water control devices are shown in a sanitary facility 2 (e.g. water usage environment). The water control devices include, for example, a urinal 21, a shower 22, a tap (or faucet) 23 and a toilet 24, as examples. The controller 11 of each water control device can communicate using Bluetooth, for example, with one or more controllers of other water control devices.

Each of the water control devices may connect and disconnect to the mesh network as it is plugged in and unplugged from the network. This is termed “plug n play’ (PnP) and so each water control device may be a PnP water control device. This enables PnP water control devices to be added and removed from the mesh network with ease. This may also enable PnP water control devices to communicate with each other. This may also enable PnP water control devices to be organised in a hierarchical structure that may be taken into account and used when adjusting operational parameters of water control devices as described herein.

It will be understood that alternative communication means other than Bluetooth may be used such as IrDA (Infrared data association protocol), local Wi-Fi communications etc.to enable the controllers of the water control devices to communicate with each other.

The mesh network is in communication with one or more BMS, one or more computing device, one or more electronic device, one or more central gateway device, one or more intermediate processing device or any combination therefor using any suitable communication protocols.

For example, the electronic device may be a mobile telephone handset, tablet device or other small computing device. Also, for example, the computing device may be a personal computer, a laptop, a server, a building management system computer as part of the BMS etc.

It will be understood that configurations that are alternative to the ones shown in FIGS. 3A to 3F may be utilised. As an example, the configuration shown in FIGS. 3A and 3B may be combined. As another example, the configuration shown in FIGS. 3A and 3C may be combined. As another example, the configuration shown in FIGS. 3A and 3D may be combined. As another example, the configuration shown in FIGS. 3A and 3E may be combined. As another example, the configuration shown in FIGS. 3B and 3C may be combined. As another example, the configuration shown in FIGS. 3B and 3D may be combined. As another example, the configuration shown in FIGS. 3B and 3E may be combined. As another example, the configuration shown in FIGS. 3C and 3D may be combined. As another example, the configuration shown in FIGS. 3C and 3E may be combined. As another example, the configuration shown in FIGS. 3D and 3E may be combined.

Further, the mesh configuration shown in FIG. 3F may be used with any of the herein described configurations or combinations.

In each of the herein described configurations or combinations, one or more of the water control devices may communicate with one or more smart water meters (not shown) located in the sanitary facility and/or the building facility. The one or more smart meters may capture data, such as water operation values, associated with the water made available to one or more of the water control devices, water made available to one or more sanitary facilities, water made available to one or more particular areas in a building facility, water made available to one or more floors of a building facility, water made available to one or more building facilities etc. For example, the water operation values may be water volume usage values, water flow rate usage values, water pressure values, historical water usage values, historical pressure values etc.

In each of the herein described configurations or combinations, the communication between the controller 11 of the water control device (21-24) and the data receiving device (100, 201, 14, smart water meter etc.) may be bi-directional.

The controller 11 of the water control device (21-24) may transmit data associated with identifying the water control device, such as the location of the water control device, a device unique identification, a device name, a device product type identification, a device product identification, etc.

The controller 11 of a first water control device (21-24) may transmit data associated with, for example, operational functions, modes of operation, operational parameters, historical device operations, warnings, messages etc. that are associated with the first water control device or another different water control device that is in communication with the first water control device.

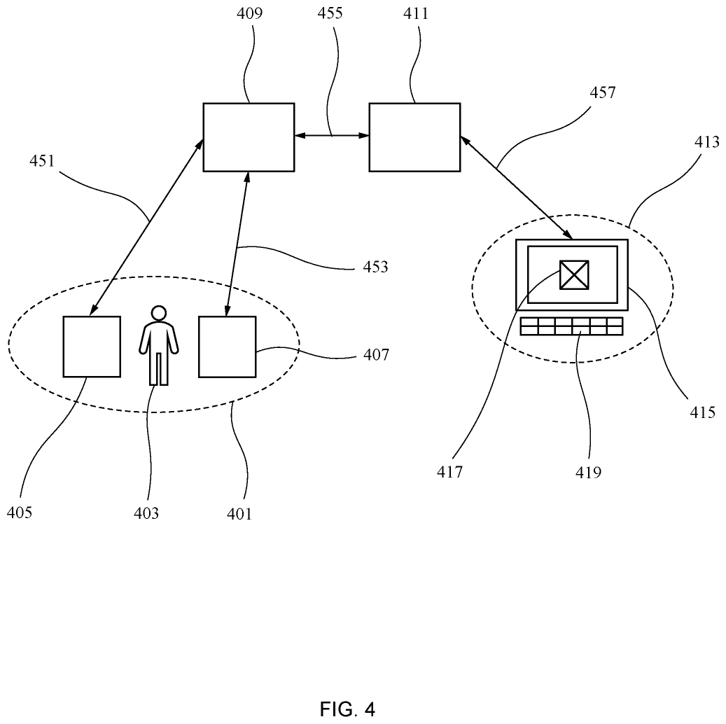

FIG. 4 shows an example system schematic diagram of a water cleansing system. A water usage environment 401 has multiple water control devices that a person (user) 403 can use. In this diagram, a water control device 405 is depicted along with a sensor 407. The water control device may be a tap or tap ware, a urinal, a cistern, a shower, a toilet, a bath, a bidet etc. The water control device may also be a water heater system or a water-cooling tower, for example. As a further example, the water control device may be a water meter, recycling hot water system, water shut-off valve, thermo mixer valve (TMV) etc.

In one example, the sensor 407 may be associated with the operation of the water control device 405. That is, the sensor may control whether the water control device 405 operates. For example, the sensor 407 may sense when a person approaches and on that basis the sensor 407 causes a controller of the water control device 405 to operate the water control device 405.

In another example, the sensor 407 may control how the water control device 405 operates. For example, gestures may be sensed by the sensor 407, which may cause the controller of the water control device 405 to operate in different modes. As another example, the sensor 407 may detect how close a person is to the sensor 407 and so the sensed “closeness” may be used by the controller of the water control device 405 to operate the water control device 405 in different modes.

In another example, the sensor 407 may operate in different modes such that in one mode the controller of the water control device 405 controls whether to and/or how to operate the water control device 405 based on the sensed signal from the sensor 407, or, in another mode, to count the number of persons using the water usage environment 401 based on the sensed signal from the sensor 407. For example, the sensor 407 may be a sensor that operates in a low-sense mode to detect a person to control, activate or operate the water control device 405 and operate in a high-sense mode to detect a person passing by the water control device 405 for counting purposes without controlling, activating or operating the water control device 405.

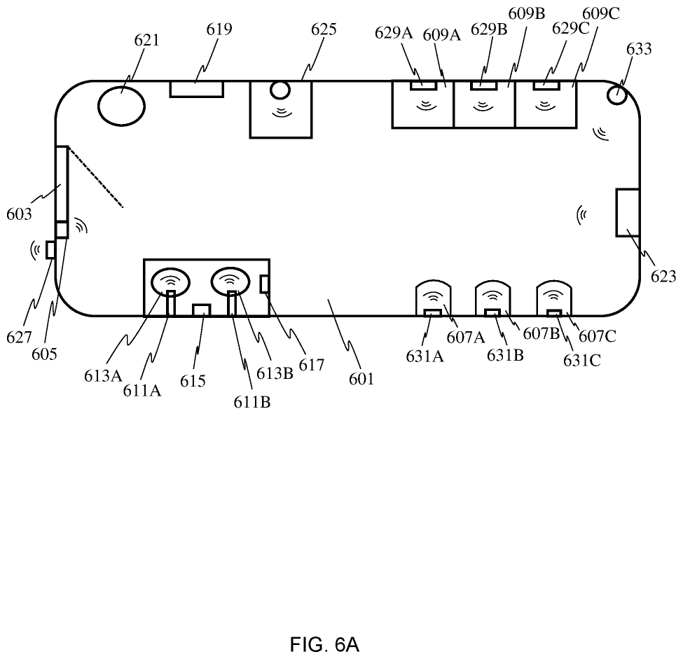

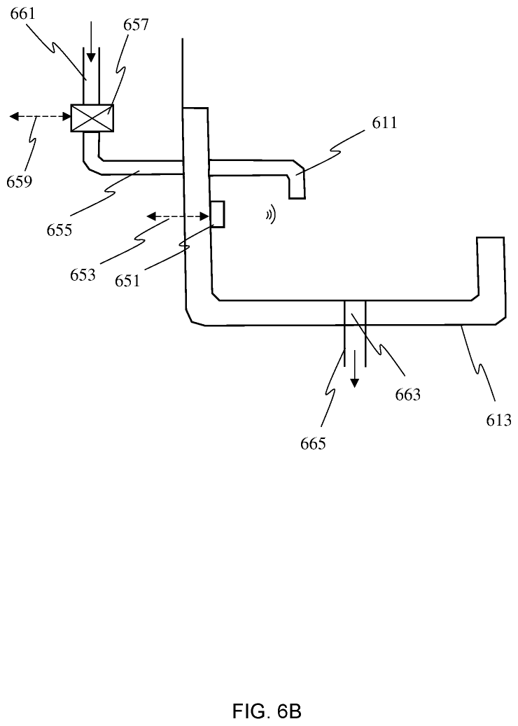

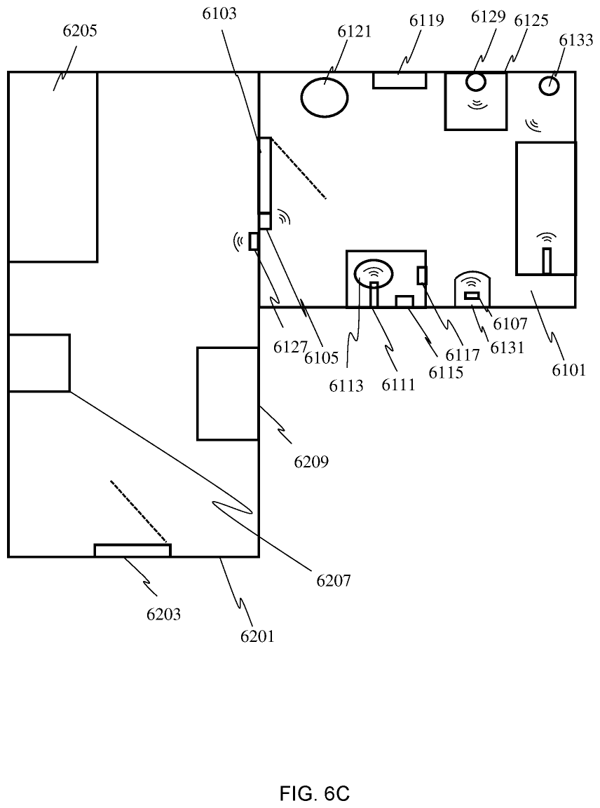

In another example, the sensor 407 may be incorporated into, in communication with, or integrated with the water control device 405. In another example, the sensor 407 may be associated with another water control device (see FIG. 6A) in the water usage environment 401. Also, in another example, the sensor 407 may be associated with a device (see FIG. 6A) in the water usage environment 401 that is not a water control device 405. In another example, the sensor 407 may be located outside of the water usage environment 401 (see FIG. 6A).

The sensor may be a door movement sensor, a person movement sensor, a water control device person sensor, a gateway sensor, a tap sensor, a toilet flush sensor, a shower sensor, a soap dispensing sensor, a bin usage and/or fullness sensor, a paper towel dispenser sensor, or any other suitable sensor that may be used in a water usage environment.

For example, the person movement sensor may be located inside or outside the water usage environment. For example, the person movement sensor may be located in a connected and/or adjacent room and/or space of the water usage environment. For example, the person movement sensor may be located in a patient's hospital room, which is located near or next to the patient's bathroom. According to another example, the person movement sensor may be located in a care home room, which is located near or next to the care home bathroom.

The soap dispensing sensor may be a soap usage sensor that senses operation of the dispenser. According to another, the soap dispensing sensor may be a soap weight sensor that measures the weight of the soap in the dispenser to determine whether soap is being used to indicate usage of the dispenser.

The bin usage sensor may use optical sensors that detect whether an object falls past the sensor and so indicates someone is using the bin.

The paper towel dispenser sensor may be a usage sensor that senses operation of the dispenser. According to another example, the paper towel dispenser sensor may be a towel weight sensor that measures the weight of the towels in the dispenser to determine whether a towel has been removed to indicate usage of the dispenser. According to another, the paper towel dispenser sensor may be a visual sensor that detects when a towel has been removed.

It will be understood that any suitable combination of the above sensor examples may be used.

A water control device communication channel 451 enables the water control device 405 to communicate to a computing device 100 as described above with reference to FIG. 1A or an electronic device 201 as described above with reference to in FIG. 2A. According to the example in FIG. 4, the computing device may be an interim processing device 409 that acts as a gateway between the water control device 405 and a server 411 and/or a Building Management System (BMS). According to another example, the water control device 405 may communicate with a computing device 100 (e.g. a laptop) or an electronic device 201 (e.g. a smart phone, laptop or tablet device) where the computing device 100 or electronic device 201 operate as the control system as described herein to perform the control methods as described herein.

The interim processing device 409 may also communicate with the sensor 407 via sensor communication channel 453 to obtain sensed signals and to control how the sensor works. It will also be understood that the sensor 407 may communicate via the water control device 405 and vice versa. Also, as explained above in relation to FIGS. 3A to 3F, different communication configurations and available to enable the water control devices to communicate internally and externally to other water control devices, other non-water usage devices in the water usage environment and other computing and/or electronic devices.

According to the example in FIG. 4 the server 411 communicates with the interim processing device 409 via communications channel 455. The server 411 also communicates with a computing device 413 via communications channel 457. The computing device includes a display 415 and a user interface 419, which may be, for example, a keyboard.

The system described is a water cleansing system for a water usage environment 401. This water cleansing system has at least one water control device 405 located within the water usage environment 401. The water control device 405 is operable to operate in a water cleansing mode for cleansing the water control device 405 and/or at least one section of pipework connected to the water control device 405. There is at least one sensor 407 for sensing whether it is safe to commence and/or continue the cleansing of the water control device 405 and/or the pipework. There is also a control system (e.g. 100, 201, 409, 411 and/or 413) that is arranged to control the water cleansing mode based on the sensing of the sensor 407.

According to one general mode of operation, the system may be a thermal cleansing system. That is, the water cleansing mode may be a thermal cleansing mode for thermally cleansing the water control device 405 and/or the pipework connected to the water control device 405, and the control system (e.g. 100, 201, 409, 411 and/or 413) may be arranged to control the thermal cleansing mode based on the sensing of the sensor 407.

For example, upon activating the thermal cleansing mode, the control system may enable a water valve, e.g. a thermal mixer valve (TMV), to operate at a defined water temperature for a defined period of time to enable hot water to flow through one or more water control devices and/or a portion of pipework (e.g. one or more water pipes or waste pipes forming the water circuit) via the thermal mixer valve. According to one example, the output temperature of the water is measured by a water temperature sensor at the water outlet of the TMV. Alternatively, the water temperature may be measured by a water temperature sensor elsewhere in the output water circuit, e.g. in the water circuit (e.g. a portion of the pipework) or at the water control device. For example, the defined water temperature may be greater than or equal to 70 degrees Celsius (e.g. 75, 74, 73, 72 or 71 degrees Celsius) and may operate for a defined period of time of a minimum of 5 minutes. As a further example, the defined water temperature may be greater than or equal to 60 degrees Celsius and may operate for a defined period of time of a minimum of 10 minutes. According to an alternative example, the defined water temperature may be in the range of 55 degrees to 65 degrees Celsius. According to a further example, the defined water temperature may be a minimum of 70 degrees Celsius, 69 degrees Celsius, 68 degrees Celsius, 67 degrees Celsius, 66 degrees Celsius, 65 degrees Celsius, 64 degrees Celsius, 63 degrees Celsius, 62 degrees Celsius, 61 degrees Celsius or 60 degrees Celsius, As another example, the defined water temperature may be in the range of 50 degrees to 70 degrees Celsius. As another example, the defined water temperature may be in the range of 60 degrees to 80 degrees Celsius. As another example, the defined water temperature may be in the range of 45 degrees to 75 degrees Celsius. As another example, the defined water temperature may be in the range of 50 degrees to 60 degrees Celsius. Further, as an example using any of the above defined temperatures and/or ranges, the defined period of time may be 1, 2, 3, 4, 5, 6, 7, 8, 9 or 10 minutes or more. For example, the defined period of time may be between 5 and 15 minutes. As a further example, the defined period of time may be between 10 and 15 minutes. For example, where higher water temperatures are used, lower periods of time may be used. Using any suitable defined temperature and defined period of time for the relevant water control devices, pipework in the water usage environment, cleansing of the water control device and the associated pipework is performed to reduce the risk of a build-up of bacteria or pathogens, such as Legionella for example.

A TMV in the described system may be configured to provide an output during a thermal cleansing mode to one or more water control devices. For example, a single TMV may provide an output during a thermal cleansing mode to a tap (or tapware) and a shower (or any other combination of water control devices). As another example, a single TMV may provide an output during a thermal cleansing mode to one or more water control devices. As another example, one or more TMVs may provide one or more outputs during a thermal cleansing mode to one or more water control devices.

Further, more than one water usage environment (e.g. bathroom) may be controlled by way of one or more splitter valves that are arranged to split the output of water to supply multiple (e.g. two or more) water usage environments. In this way, multiple water usage environments can undergo the thermal cleansing process where only a single water usage environment has received the control signals to undergo the thermal cleansing process.

According to a further example, if the defined water temperature is not reached within a defined time after the water control device has been activated to carry out the thermal cleansing process, a further operation may be implemented. According to one example of a further operation, if the defined water temperature is not reached within a defined time, but the measured water temperature is within a defined operable range of the defined water temperature (e.g. within 10, 9, 8, 7, 6, 5, 4, 3, 2 or 1 degrees Celsius of the defined water temperature), then the system may continue the thermal cleansing process by increasing the defined period of time for performing the thermal cleansing process. That is, for lower measured output temperatures, which are still within a suitable operable range, the time for performing the thermal cleansing process may be extended to carry out a suitable thermal cleanse.

According to another example of a further operation, if the defined water temperature is not reached within a defined time, the system may generate an alarm signal. For example, one or more of the connected controllers (11) may generate the alarm signal. The alarm signal may be fed back to the BMS, or any other connected computing system, to cause an alarm to be generated to indicate that the thermal cleansing process has not been completed.

According to another example of a further operation, if the defined water temperature is not reached within a defined time, and the measured water temperature is not within a defined operable range of the defined water temperature, the system may generate an alarm signal. For example, one or more of the connected controllers (11) may generate the alarm signal. The alarm signal may be fed back to the BMS, or any other connected computing system, to cause an alarm to be generated to indicate that the thermal cleansing process has not been completed.

According to another general mode of operation, the water cleansing system may be a standing water cleansing system. That is, the water cleansing mode may be a standing water cleansing mode for cleansing standing water from the water control device 405 and/or the pipework connected to the water control device 405, and the control system (100, 201, 409, 411 and/or 413) may be arranged to control the standing water cleansing mode based on the sensing of the sensor 407.

For example, upon activating the standing water cleansing mode, the water control device may operate under control of the control system to output cold water for a defined period of time to enable the cold water to flow through the water control device and/or the pipework (e.g. one or more water pipes or waste pipes forming the water circuit) in order to clear any standing water in the water circuit. For example, the cold water may be at a defined and/or monitored water temperature or merely just an unheated room temperature. As an example, the defined period of time may be 10, 20, 30, 40, 50, 60 seconds or more. This cleanses the water control device and the associated pipework to reduce the risk of a build-up of bacteria or pathogens that may breed in standing water.

The control system (e.g. 100, 201, 409, 411 and/or 413) determines whether it is safe to activate the water cleansing mode for one or more water control devices in one or more water usage environments based on the sensing by one or more sensors. Upon the control system reaching a positive determination, the control system enables the water cleansing mode to be activated.

For example, the control system may activate the water cleansing mode upon receiving an activation signal based on a user input, such as pressing a button on a keypad or smart phone.

As another example, the control system may enable the water cleansing mode to be activated by generating and outputting an indication indicating that it is safe to activate the water cleansing mode. For example, as shown in FIG. 4, an indication 417 may be displayed on the display 415 of the computer 413. As an example, this indication may then enable a user to select an input via the computer to activate the water cleansing mode. As another example, the indication may be an operable button that is displayed on the display, which is a touch sensitive display. Upon operating the operable button, an activation signal may be generated to cause the control system to activate the water cleansing mode. The indication may be at least one of a visual, audible, haptic indication, or a display of a message, symbol, colour, sound, and vibration, for example.

It will be understood that the control system (e.g. 100, 201, 409, 411 and/or 413) that activates the water cleansing mode bay be the same or different to the control system (e.g. 100, 201, 409, 411 and/or 413) that enables the water cleansing mode to be activated.

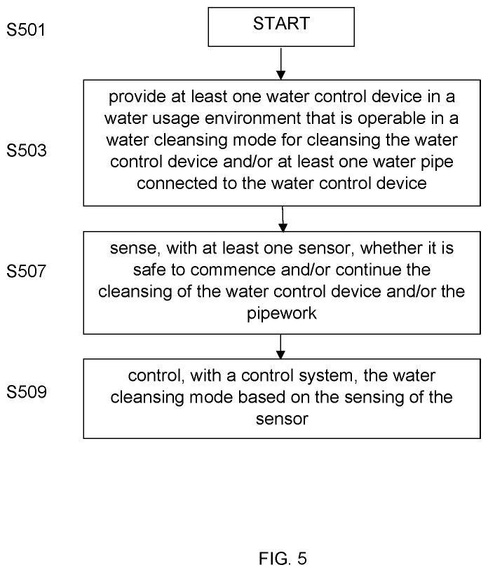

FIG. 5A shows a process flow diagram according to an example of operation of the water cleansing system and method.

The process starts at step S501. At step S503, the process provides at least one water control device in a water usage environment that is operable in a water cleansing mode for cleansing the water control device and/or at least a portion of pipework connected to the water control device. At step S505, the process senses, with at least one sensor, whether it is safe to commence and/or continue the cleansing of the water control device and/or the pipework. At step S507, the process controls, with a control system, the water cleansing mode based on the sensing of the sensor.

FIG. 6A shows an example of a water usage environment in accordance with a described embodiment.

An example of a water usage environment 601 is shown in which the water usage environment is a commercial bathroom, such as a bathroom in a work place (e.g. an office or factory), airport, shopping mall, hospital, aged care facility etc. Entry to the water usage environment 601 is via a door 603. A door movement sensor 605 may be provided to sense movement of the door (e.g. using a magnetic or visual sensor). One or more urinals (607A-607C) may be provided. One or more toilets (609A-609C) may be provided in cubicles. One or more taps (611A, 611B) may be provided. The taps may have a built-in operation sensor to cause the tap to operate, or a sensor nearby that is associated with that tap to cause the tap to operate. One or more sinks (613A, 613B) may be provided. One or more soap dispensers 615 may be provided. One or more towel dispensers 617 may be provided. One or more hand and/or hair dryers 619 may be provided. One or more bins 621 may be provided. One or more air fresheners/deodorisers 623 may be provided. One or showers 625 may be provided. An external sensor 627 may also be provided to sense when a person is approaching/leaving the water usage environment. The external sensor 627 may also be used to capture electronic identification from authorised persons approaching, entering or leaving the water usage environment. For example, the external sensor 627 may be a Bluetooth sensor, RFID sensor, near field communication (NFC) sensor, etc. that can communicate with an electronic device to access, retrieve, obtain and/or share identification, authorisation and/or authentication data. One or more toilet flush sensors (629A-629C) may be provided. One or more urinal flush sensors (631A-631C) may be provided. The water usage environment may also have an interim processing device in the form of a gateway 633 between one or more of the water control devices and/or sensors, and a server 411 and/or a Building Management System (BMS). The gateway 633 may also have a sensor attached thereto to sense whether the water usage environment is occupied.

It will be understood that a water usage environment may have any number of (including zero), and any combination of, the above described water usage devices.

FIG. 6B shows an example of a water control device and sensor in accordance with a described embodiment. FIG. 6B shows an example of a water control device and sensor in the form of a tap 611 over a sink 613. The tap 611 has an associated operation sensor 651 that, upon activation, causes the tap to operate.

As an example, the sensor 651 may sense a person's hand (for example) approaching the tap, and then send a control signal via a communication channel (653) to a controller (not shown) to enable water to flow by activating a valve 657 that has a water pipe 655 connected to the tap 611. The valve 657 receives water via a water inlet 661. The valve receives control signals from the controller via a communication channel 659.

Water flows from the tap 611 into the sink 613 through the drain 663 and out through the outlet pipework 665 enabling a person to wash their hands.

FIG. 6C shows an example of a water usage environment in accordance with a described embodiment.

An example of a water usage environment 6101 is shown in which the water usage environment is a bathroom off a main room 6201 in a hospital, care home, aged care facility or the like. For example, the main room 6201 may be a private hospital; room or private care home room. Further, the water usage environment 6101 may be an en-suite bathroom. The main room 6201 may be entered via a door 6203. The room 6201 may have any number of items of furniture for the person using the room such as a bed 6205, chair 6207 and table 6209.

Entry to the water usage environment 6101 is via a door 6103. A door movement sensor 6105 may be provided to sense movement of the door (e.g. using a magnetic or visual sensor). One or more urinals and/or toilets 6107 may be provided. One or more taps 6111 may be provided. The taps may have a built-in operation sensor to cause the tap to operate, or a sensor nearby that is associated with that tap to cause the tap to operate. One or more sinks 6113 may be provided. One or more soap dispensers 6115 may be provided. One or more towel dispensers 6117 may be provided. One or more hand and/or hair dryers 6119 may be provided. One or more bins 6121 may be provided. One or showers 6125 may be provided. An external sensor (i.e. external to the water usage environment) 6127 may also be provided to sense when a person is approaching/leaving the water usage environment. The external sensor 627 may also be used to capture electronic identification from authorised persons approaching, entering or leaving the water usage environment 6101. For example, the external sensor 6127 may be a Bluetooth sensor, RFID sensor, near field communication (NFC) sensor, etc. that can communicate with an electronic device to access, retrieve, obtain and/or share identification, authorisation and/or authentication data. One or more shower usage sensors 6129 may be provided. One or more urinal and/or toilet flush sensors 6131 may be provided. Further, other devices may be provided as needed, e.g. air fresheners/deodorisers, etc.

The water usage environment may also have an interim processing device in the form of a gateway 6133 between one or more of the water control devices and/or sensors, and a server 411 and/or a Building Management System (BMS). The gateway 6133 may also have a sensor attached thereto to sense whether the water usage environment is occupied.

It will be understood that a water usage environment may have any number of (including zero), and any combination of, the above described water usage devices.

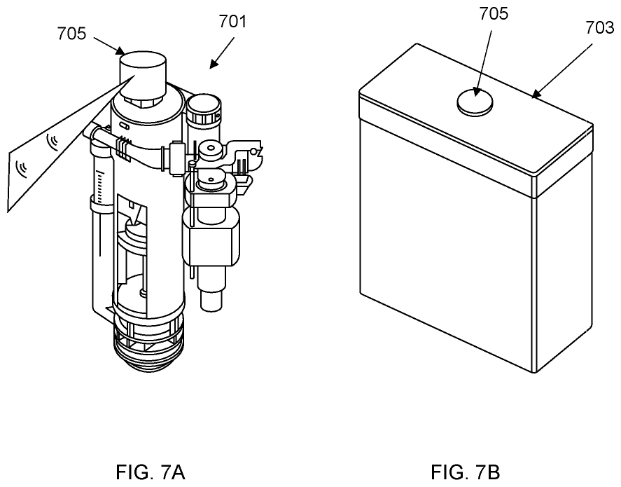

FIGS. 7A and 7B show an example of a water control device and sensor in the form of a toilet flush 701 with hi-sense and low-sense functionality. FIG. 7A shows the toilet flush outside of a cistern 703. FIG. 7B shows the toilet flush fixed 701 in place in the cistern 703 with a sensor 705 protruding out the top of the cistern 703. In a low-sense mode, a sensor 705 operates in a mode that can detect a person, or part of a person, to cause the toilet flush to operate. In a high-sense mode, the sensor 705 (as shown in FIG. 7) operates in a mode that can detect a person, or part of a person, to count a person in the vicinity of the sensor 705, and so in the vicinity of the water usage environment. It will be understood that any of the water control devices described herein may utilise a sensor that can operate in a low sense mode or a high sense mode. Some sensors may only operate in a low sense mode for the purpose of operating a water control device, and some sensors may only operate in a high-sense mode for the purposes of detecting and/or counting people. It will be understood that any of the other devices (e.g. towel dispenser, soap dispenser, door sensor, bin usage sensor etc.) in the water usage environment may utilise a sensor that can operate in a high sense mode for the purposes of detecting and/or counting people. Further, the interim processing device (e.g. gateway) in the water usage environment may utilise a sensor that can operate in a high sense mode for the purposes of detecting and/or counting people. One or more sensors may be connected using a mesh network in order to share data for a particular water usage environment to enable a control or computing device to detect that the water usage environment is occupied.

The high-sense mode may be used to monitor the number of people using the water usage environment, or one or more devices in the water usage environment. Further, the high-sense mode may be used to determine whether there is a person approaching, entering or within a water usage environment.

It will be understood that sensors associated with other water control devices may be operated in a low-sense and/or a high-sense mode. It will also be understood that sensors associated with other devices (e.g. soap dispensers, towel dispensers, hand/hair dryers, bins, air fresheners, deodorisers etc.) may also be operated in a low sense and/or a high-sense mode. It will also be understood that other components (e.g. interim processing device, gateway, light fittings, switches etc.) in the water usage environment may have sensors that operate in a person detection mode.

Therefore, at least one sensor associated with one of the water control devices and/or other devices may be used to sense whether at least one person is entering, within, in proximity to or exiting the water usage environment. The sensor signal may be used by a control system to generate an occupancy signal for use by the control system.

If a sensor does not have a high-sense and low-sense mode, the signal produced by the sensor to operate the device (whether it be a water control device or other device in the water usage environment) may be used by a control system to generate an occupancy signal for use by the control system.

The control system may control the water cleansing mode based on the occupancy signal, as explained in more detail herein. The occupancy signal may indicate current occupancy of the water usage environment by the person, potential future occupancy of the water usage environment by the person or non-occupancy of the water usage environment, and the control system may then control the water cleansing mode accordingly.

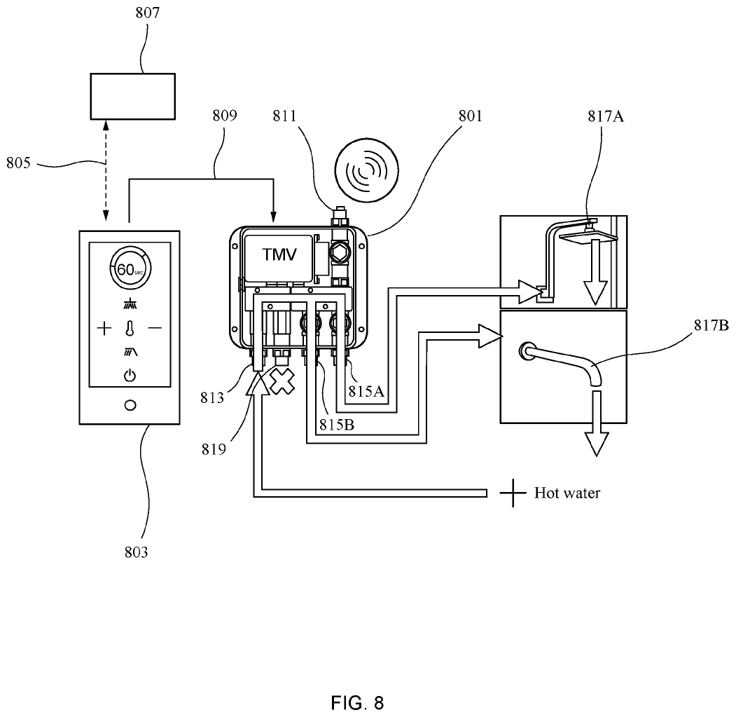

FIG. 8 shows an example of a thermal mixer valve (TMV) 801 for use in the thermal cleansing mode. When in the thermal cleansing mode, the control system enables a TMV to operate at a defined water temperature for a defined period of time to enable hot water to flow through the water control device and/or the water pipe via the TMV.

Shown in FIG. 8 is a water temperature controller 803 that can be controlled by a control signal received via a communication channel 805 from a control system 807 (e.g. a computer device 100, an electronic device 201, an interim processing device 409, a server 411 and/or a computing device 413 (e.g. part of a BMS)).

The TMV 801 may receive a control signal from the water temperature controller 803 via a communication channel 809 to flush hot water through one or more water control devices to thermally cleanse the water control devices and their associated pipework. For example, the TMV 801 may be dual-purpose where a single TMV 801 may be used to provide water to two different devices (e.g. a tap and a shower, a tap and a bath, a shower and a bath etc. This may be particularly useful in an environment where the usage water environment is an en-suite bathroom as described, for example, with reference to FIG. 6C)

According to this example, the TMV 801 has a cold water inlet 811, a hot water inlet 813 and two hot water outlets (815A, 815B). A first hot water outlet 815A provides hot water (at a temperature controlled by the water temperature controller 803) to a first water control device 817A (e.g. a shower head). A second hot water outlet 815B provides hot water to a second water control device 817B (e.g. a tap).

The TMV 801 also has a cold water outlet 819 that may be connected to one or more water control devices and pipework. The TMV 801 may receive a control signal from the water temperature controller 803 via a communication channel 809 to flush cold water through one or more water control devices to cleanse the water control devices and their associated pipework by removing standing water.

A determination of whether the cleansing mode can start, proceed, continue or discontinue is made by the control system based on one or more sensor signals that are received from the one or more sensors associated with the water usage environment.

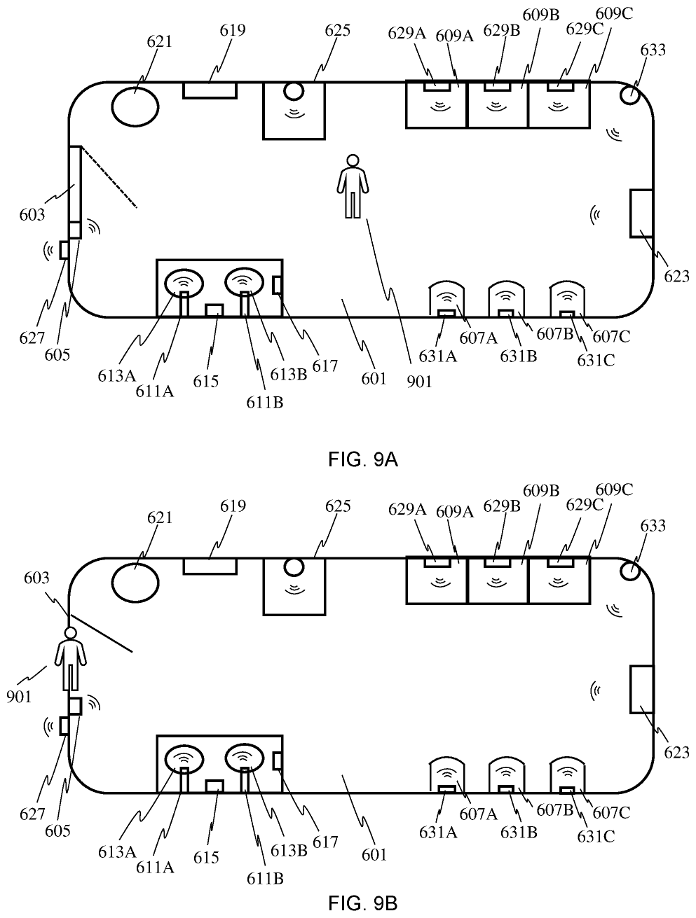

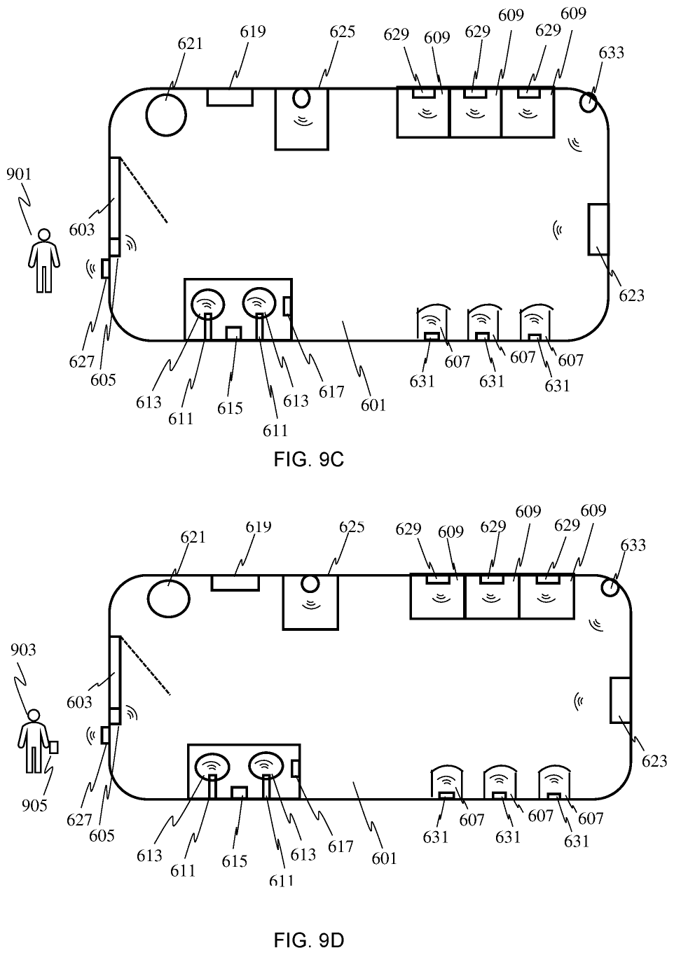

FIGS. 9A to 9D depict various scenarios for controlling the water cleansing safety functions associated with a water usage environment. It will be understood that, although the examples provided are shown with reference to the water usage environment described with reference to FIG. 6A, the scenarios are also applicable to other water usage environments, such as that shown in FIG. 6C. That is, any of the sensors described with reference to 6C may be utilised in the same or similar way to perform the same functionality described herein with reference to FIGS. 9A to 9D.

In FIG. 9A, the water usage environment is the same as described above with reference to FIG. 6A in which the same reference numerals are used. As referred to above, the scenario described may apply to other water usage environments, such as that shown in FIG. 6C.

According to this example, a person 901 is located within the water usage environment 601. A sensor, such as the sensor 631A in the urinal operating in a high-sense mode, senses the person and sends an occupancy signal to the control system (e.g. 100, 201, 409, 411 and/or 413). Based on receipt of the occupancy signal, the control system may generate an indication that the water usage environment 601 is occupied. Further, the control system may control the cleansing mode based on the occupancy signal from the sensor by i) stopping activation of the cleansing mode for the water usage environment 601, ii) disabling activation of the cleansing mode for the water usage environment 601, iii) stopping or shutting down the cleansing mode operation that has already started in the water usage environment 601.

It will be understood that any one or more of the sensors in the water usage environment 601 may be used to generate an occupancy signal based on the detection of a person in the water usage environment.

In FIG. 9B, the water usage environment is the same as described above with reference to FIG. 6A in which the same reference numerals are used. As referred to above, the scenario described may apply to other water usage environments, such as that shown in FIG. 6C.

According to this example, a person 901 is entering the water usage environment 601 via the door 901. The door movement sensor 627 senses the person and sends an occupancy signal to the control system (e.g. 100, 201, 409, 411 and/or 413). Based on receipt of the occupancy signal, the control system may generate an indication that the water usage environment 601 is now occupied. Further, the control system may control the cleansing mode based on the occupancy signal from the sensor by i) stopping activation of the cleansing mode for the water usage environment 601, ii) disabling activation of the cleansing mode for the water usage environment 601, and iii) stopping or shutting down the cleansing mode operation that has already started in the water usage environment 601.

It will be understood that any one or more of the sensors in the water usage environment 601 may be used to generate an occupancy signal based on the detection of a person entering the water usage environment.

In FIG. 9C, the water usage environment is the same as described above with reference to FIG. 6A in which the same reference numerals are used. As referred to above, the scenario described may apply to other water usage environments, such as that shown in FIG. 6C.

According to this example, a person 901 is approaching the water usage environment 601. An external sensor 627 senses the person and sends an occupancy signal to the control system (e.g. 100, 201, 409, 411 and/or 413). Based on receipt of the occupancy signal, the control system may generate an indication that the water usage environment 601 is about to be occupied. Further, the control system may control the cleansing mode based on the occupancy signal from the sensor by i) stopping activation of the cleansing mode for the water usage environment 601, ii) disabling activation of the cleansing mode for the water usage environment 601, iii) stopping or shutting down the cleansing mode operation that has already started in the water usage environment 601, iv) locking the door 603 to stop the person from entering the water usage environment (to enable the cleansing mode to continue).

In FIG. 9D, the water usage environment is the same as described above with reference to FIG. 6A in which the same reference numerals are used. As referred to above, the scenario described may apply to other water usage environments, such as that shown in FIG. 6C.

According to this example, a person 903 is approaching the water usage environment 601. In this example, the person is an authorised person 903, such as a manager, cleaner or service person. The authorised person may carry a credential, either physical (e.g. company identification, barcode, QR code etc.) or electronic (e.g. a token stored on an electronic device, or fob, for example). An external sensor 627 detects and/or reads the credential associated with the authorised person. An authorisation signal may be generated based on the credential. The control system is arranged to control the water cleansing mode based on the authorisation signal. For example, the control system may modify the water cleansing mode (e.g. by not stopping the water cleansing mode) upon a determination that the authorised person, e.g. manager, cleaner and/or service person, has a credential that permits the water cleansing mode to be modified. The water cleansing mode may be modified by allowing the water cleansing mode to continue in the event that the authorised person, e.g. the manager, cleaner and/or service person, approaches and/or enters the water usage environment.

The external sensor 627 may sense the credential and may send the credential to the control system (e.g. 100, 201, 409, 411 and/or 413), which generates an authorisation signal. The external sensor 627 may sense the credential, generate an authorisation signal and send the authorisation signal to the control system (e.g. 100, 201, 409, 411 and/or 413).

The control system may control the cleansing mode based on the authorisation signal by i) stopping activation of the cleansing mode for the water usage environment 601, ii) disabling activation of the cleansing mode for the water usage environment 601, iii) stopping or shutting down the cleansing mode operation that has already started in the water usage environment 601, iv) locking the door 603 to stop the person from entering the water usage environment (to enable the cleansing mode to continue), or v) enabling the cleansing mode to continue even if the person 903 enters the water usage environment.

Where the water cleansing mode has been activated by the control system, the control system may then deactivate the water cleansing mode upon a determination that at least one person is within, approaching and/or entering the water usage environment based on the sensing of the sensor. According to one example, deactivating the water cleansing mode may involve the control system stopping hot water from flowing through the water control device and/or the pipework. According to another example, deactivating the water cleansing mode may involve the control system stopping hot water from flowing in the water usage environment. According to another example, deactivating the water cleansing mode may involve the control system diverting hot water flowing out of a water control device to an auxiliary water outlet. According to another example, deactivating the water cleansing mode may involve the control system stopping a water control device from functioning. According to another example, deactivating the water cleansing mode may also include the control system generating an audible or visible indication that a water control device is not to be used. According to another example, deactivating the water cleansing mode may also include the control system generating and/or displaying an indication that a water control device is out of service. According to another example, deactivating the water cleansing mode may involve the control system causing cold water to flow through the water control device to cool the water control device down.

According to one example, the water cleansing system may have multiple water control devices. Each of these water control devices may have an associated sensor, which may be integrated into the water control device or separate from the water control device. Each water control device may be connected to other water control devices via a wireless network. The control system may be arranged to control the water cleansing mode of any one water control device based on the sensing of the sensor associated with any one other water control device. Further, the control system may be arranged to control the water cleansing mode of any one water control device based on the sensing of the sensor associated with any one other device in the water usage environment.

According to one example, a facility manager (e.g. from a hospital) may first confirm via signals received from the BMS or server that sensors for detecting persons in the water usage environment indicate that there are no persons (e.g. patients, visitors or staff) within the water usage environment. The sensor detection process operates via the devices in the water usage environment. Optionally, the signals may be transmitted via a gateway device and/or using BT5 mesh network. Detecting product operation as a people detection system may provide a failsafe system where the facility manager can only commence the thermal disinfection process knowing that it is safe to do so. The system may provide a failsafe function to ensure that the thermal disinfection process cannot proceed without approval from a person who has the correct level of credentials.

For example, the system may enable a green screen to be shown to a user to indicate that it is safe for the thermal disinfection process to commence, or a red screen to indicate that it is not safe for the thermal disinfection process to commence.

When it is safe for the thermal disinfection process to commence, the facility manager and/or building management system may initiate, either manually or automatically, the thermal disinfection process where, for example, hot (e.g. 65 degrees) water passes through the water system and out through the water control device (e.g. tapware spout or shower head outlet) at 65 degrees for 3 minutes. If one or more sensors identify any person approaching, entering or being within the water usage environment, the system may immediately shut down the thermal disinfection process and may notify the facility manager.

According to a further example of operation, a control signal may be generated by the BMS (for example, based on a manual operation by a building manager), and communicated to a TMV and/or water control device. As an alternative, the control signal may be generated by another person that has approved access via another connected computing device.

The signal may be communicated to the water control device via a gateway device located in, or near to, the water usage environment and/or a TMV. In one example, the water control device may be a shower, in which a controller (11) in a shower interface of the shower receives the control signal and adjusts the water temperature of the water to be output from the shower. The controller (11) may then cause the water to be output from the showerhead of the shower, e.g. via an associated TMV, at the temperature set according to the control signal in order to commence the thermal disinfection process.

According to one example, the controller (11) of the shower interface may communicate with one or more other water control devices in the water usage environment to cause them to commence the thermal disinfection process.

According to one example, the TMV that is providing the heated water for the thermal cleansing of the shower may also provide heated water to one or more taps (or tapware), and/or other connected water control devices.

According to one example, water control device operations may change from a “master” control mode to a “slave” control mode when switching from a “normal” operational mode to a thermal cleansing mode. That is, when in a “master” control mode, the water control device is arranged to control itself. Whereas, when in a “slave” control mode, the water control device is arranged to be controlled by another water control device and/or a connected TMV.

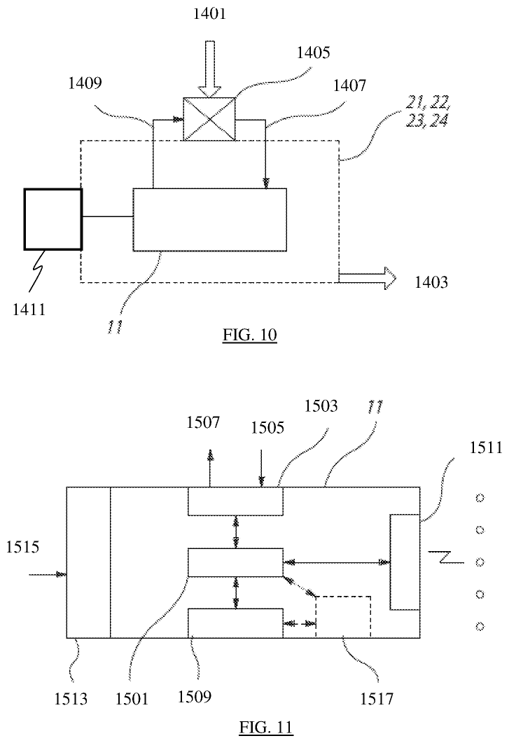

FIG. 10 shows an example water control device (e.g. 21, 22, 23, 24) schematic diagram with a controller 11. An inlet water flow 1401 and outlet water flow 1403 is shown. An inlet water valve 1405 is in fluid connection between the inlet water flow 1401 and the water control device. In this example, the inlet water valve 1405 communicates, via communication channel 1407, one or more water operation values to the controller. An operational parameter associated with the water control device during the device operation may be sent by the controller and communicated to the inlet water valve via communication channel 1409. Further, a sensor 1411 associated with the water control device provides sensor signals to the controller 11. The sensor 1411 may be part of or separate to the water control device.

According to a further example, the system may operate to cleanse pipework in the water circuit where water may build up, become stagnant or otherwise not flow freely on a regular basis. That is, in so-called “dead leg” pipework where water does not freely flow freely on a regular basis, the system may operate to control the flow of water through two or more water control devices for a defined period of time in a manner that causes the water to flow through one or more defined portions of pipework where water does not freely flow freely on a regular basis.

According to one example, data (e.g. in the form of a look-up table) may be stored in memory to instruct the control system how to operate the two or more water control devices to enable water to flow through the one or more portions of pipework (i.e. a portion of a water circuit). An example Table 1 is provided below purely for illustrative purposes in which turning on two or more of the water control devices while keeping other water control devices switched off causes water to flow through the pipework connected to those water control devices so that the water passes through the desired pipework portion (e.g. A, B, C, D, E). Therefore, a selection of one, two or more water control devices may be operated in accordance with a defined operation protocol.

TABLE 1

| Water | | | | | |
|---|---|---|---|---|---|
| Control | Pipework | Pipework | Pipework | Pipework | Pipework |
| Devices | Portion A | Portion B | Portion C | Portion D | Portion E |
| A | ON | ON | OFF | OFF | ON |
| B | OFF | ON | ON | OFF | OFF |
| C | ON | OFF | ON | ON | ON |
| D | OFF | ON | OFF | ON | ON |
| E | OFF | OFF | OFF | ON | ON |

Further, one or more of the timing, duration, sequence, pressure, flow rate etc. of the water flow through the water control devices may be controlled, adjusted, dynamically changed in order to cause the water to pass through the defined pipework portion.

This may be particularly useful in buildings where water usage environments and/or water control devices are unused for a period of time, such as, for example, empty hotel rooms, empty bathrooms, empty hospital rooms, empty care rooms etc.

It will also be understood that the selection of one, two or more water control devices may be operated in accordance with a defined operation protocol using heated water in order to thermally cleanse the water control device(s) and pipework.

FIG. 11 shows an example of a controller 11 of a water control device.

The controller 11 has a microprocessor 1501 that is in communication with an input/output (I/O) interface 1503 that receives incoming signals 1505 and transmits outgoing signals 1507. The microprocessor also communicates with a memory 1509 to enable incoming data to be stored and stored data to be retrieved and transmitted. The microprocessor also communicates with a communications interface 1511 for communicating with one or more other water control devices, computer devices, electronic devices, smart water meters, intermediate processing devices, BMS etc. The controller 11 and its components are powered by a power system 1513 that either has an external power inlet 1515 or is powered by an internal power store (e.g. a battery).

The memory 1509 may store one or more profiles and/or operation tables associated with one or more device operations associated with one or more water control devices.

The controller 11 in one water control device may communicate with controllers in one or more other water control devices. For example, a first controller may obtain data from a memory 1509 in another controller, or a smart water meter.

The controller 11 may have an artificial intelligence (AI) and/or machine learning (ML) module 1517 integrated therein. The AI/ML module communicates with the microprocessor 1501 and memory 1509.

The controller 11 in one water control device may communicate with an AI/ML module 1517 in one or more other water control device, electronic device 201, computing system 100, building management system etc.

It will be understood that the AI/ML module may also be an AI/ML system that is separate to the controller 11 but in communication with the controller. For example, the AI/ML system may be at least part of a computer system or electronic device as described herein with reference to FIGS. 1A, 1B, 2A, 2B, where the computer system or electronic device is in communication with the controller 11 via any suitable communication means as described herein.

The AI/ML module or system may also communicate with one or more smart meters to obtain water operation values. The AI/ML system or module may include an artificial neuronal net and/or an expert system. The AI/ML system or module may be trained using supervised learning, where the AI/ML system is trained with pre-defined data.

### INDUSTRIAL APPLICABILITY

The arrangements described are applicable to the building management systems industries and particularly for the sanitary facility management industry.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A water cleansing system for a water usage environment, the system comprising:
at least one water control device in the water usage environment, wherein the water control device is operable to operate in a water cleansing mode for cleansing the water control device and/or at least a portion of pipework connected to the water control device,
at least one sensor for sensing whether it is safe to commence and/or continue the cleansing of the water control device and/or the pipework, and
a control system arranged to control the water cleansing mode based on the sensing of the sensor.

2. The system of claim 1, wherein the water cleansing system is a thermal cleansing system, the water cleansing mode is a thermal cleansing mode for thermally cleansing the water control device and/or the pipework connected to the water control device, and the control system is arranged to control the thermal cleansing mode based on the sensing of the sensor.

3. The system of claim 2, wherein the thermal cleansing mode enables a thermal mixer valve to operate at a defined water temperature for a defined period of time to enable hot water to flow through the water control device and/or the pipework via the thermal mixer valve.

4. The system of claim 1, wherein the water cleansing system is a standing water cleansing system, the water cleansing mode is a standing water cleansing mode for cleansing standing water from the water control device and/or the pipework connected to the water control device, and the control system is arranged to control the standing water cleansing mode based on the sensing of the sensor.

5. The system of claim 4, wherein the standing water cleansing mode enables the water control device to operate at a defined water temperature for a defined period of time to enable cold water to flow through the water control device and/or the pipework.

6. The system of claim 1, wherein the at least one sensor senses whether at least one person is entering, within, in proximity to or exiting the water usage environment, to generate an occupancy signal for use by the control system, wherein the control system is arranged to control the water cleansing mode based on the occupancy signal.

7. The system of claim 6, wherein the occupancy signal indicates current occupancy of the water usage environment by the person, potential future occupancy of the water usage environment by the person or non-occupancy of the water usage environment.

8. The system of claim 1, wherein the control system determines whether it is safe to activate the water cleansing mode based on the sensing by the sensor and, upon a positive determination, enables the water cleansing mode to be activated.

9. The system of claim 8, wherein the control system activates the water cleansing mode upon receiving an activation signal.

10. The system of claim 8, wherein the control system enables the water cleansing mode to be activated by generating and outputting an indication indicating that it is safe to activate the water cleansing mode.

11. The system of claim 10, wherein the indication is an operable button that is displayed that, upon operating, generates an activation signal to cause the control system to activate the water cleansing mode.

12. The system of claim 10, wherein the indication is at least one of a visual, audible, haptic indication, display of a message, symbol, colour, sound, and vibration.

13. The system of claim 1, wherein the control system determines whether it is safe to activate the water cleansing mode based on the sensing by the sensor and, upon a positive determination, activates the water cleansing mode.

14. The system of claim 1, wherein the sensor is for sensing at least one person approaching, entering, being within or exiting the water usage environment.

15. The system of claim 1, wherein the sensor comprises at least one of a door movement sensor, a person movement sensor, a water control device sensor, a gateway sensor, a tap sensor, a toilet flush sensor, a shower sensor, a soap dispensing sensor, a bin usage sensor, a paper towel dispenser sensor.

16. The system of claim 1, wherein the sensor is incorporated into, in communication with, or integrated with the water control device.

17. The system of claim 1, wherein the sensor is a sensor that operates in a low-sense mode to detect the person to activate the water control device, and operates in a high-sense mode to detect the person is nearby to the sensor without activating the water control device.

18. The system of claim 1, wherein the water cleansing system comprises a plurality of the water control device, each water control device having an associated sensor, wherein each water control device is connected via a wireless network, wherein the control system is arranged to control the water cleansing mode of any one water control device based on the sensing of the sensor associated with any one other water control device.

19. The system of claim 1, wherein the water cleansing system comprises a plurality of the water control device, each water control device having an associated sensor, wherein each water control device is connected via a wireless network, wherein the control system may be arranged to control the water cleansing mode of any one water control device based on the sensing of the sensor associated with any one other device in the water usage environment.

20. The system of claim 1 comprising at least one further sensor arranged to detect a credential associated with at least one authorised person, and generate an authorisation signal based on the credential, wherein the control system is arranged to control the water cleansing mode based on the authorisation signal.

21. The system of claim 20, wherein the control system modifies the water cleansing mode upon a determination that the authorised person has a credential that permits the water cleansing mode to be modified.

22. The system of claim 21, wherein the water cleansing mode is modified by allowing the water cleansing mode to continue in the event the authorised person approaches and/or enters the water usage environment.

23. The system of claim 1 whereupon activation of the water cleansing mode by the control system, the control system is further arranged to deactivate the water cleansing mode upon a determination that at least one person is within, approaching and/or entering the water usage environment based on the sensing of the sensor.

24. The system of claim 23, wherein deactivating the water cleansing mode comprises one or more of the control system: stopping hot water from flowing through the water control device and/or the pipework; stopping hot water from flowing in the water usage environment; diverting hot water flowing out of a water control device to an auxiliary water outlet; stopping a water control device from functioning; generating an audible or visible indication that a water control device is not to be used; generating an indication that a water control device is out of service; causing cold water to flow through the water control device to cool the water control device down.

25. A water cleansing method for a water usage environment comprising at least one water control device in a water usage environment that is operable in a water cleansing mode for cleansing the water control device and/or at least a portion of pipework connected to the water control device, the method comprising the steps of:
sensing, with at least one sensor, whether it is safe to commence and/or continue the cleansing of the water control device and/or the pipework, and
controlling, with a control system, the water cleansing mode based on the sensing of the sensor.

26. The method of claim 25, wherein the water cleansing mode is a thermal cleansing mode for thermally cleansing the water control device and/or the pipework connected to the water control device, and the method comprises the step of controlling the thermal cleansing mode based on the sensing of the sensor.

27. The method of claim 26, further comprising the step of operating a thermal mixer valve at a defined water temperature for a defined period of time to enable hot water to flow through the water control device and/or the pipework via the thermal mixer valve.

28. The method of claim 25, wherein the water cleansing mode is a standing water cleansing mode for cleansing standing water from the water control device and/or the pipework connected to the water control device, and the method comprises the step of controlling the standing water cleansing mode based on the sensing of the sensor.

29. The method of claim 28, further comprising the step of operating the water control device at a defined water temperature for a defined period of time to enable cold water to flow through the water control device and/or the pipework.

30. The method of claim 25, further comprising the step of sensing whether at least one person is entering, within, in proximity to or exiting the water usage environment, to generate an occupancy signal for use by the control system, and controlling the water cleansing mode based on the occupancy signal.

31. The method of claim 30, wherein the occupancy signal indicates current occupancy of the water usage environment by the person, potential future occupancy of the water usage environment by the person or non-occupancy of the water usage environment.

32. The method of claim 25, further comprising the steps of determining whether it is safe to activate the water cleansing mode based on the sensing by the sensor and, upon a positive determination, enabling the water cleansing mode to be activated.

33. The method of claim 25, further comprising the steps of enabling the water cleansing mode to be activated by generating and outputting an indication indicating that it is safe to activate the water cleansing mode.

34. The method of claim 25, further comprising the steps of outputting an operable button as the indication, and generating an activation signal to activate the water cleansing mode upon operation of the button.

35. The method of claim 25, further comprising the steps of determining whether it is safe to activate the water cleansing mode based on the sensing by the sensor and, upon a positive determination, activating the water cleansing mode.

36. The method of claim 25, further comprising the step of sensing at least one person approaching, entering, being within or exiting the water usage environment.

37. The method of claim 25, further comprising the step of operating the sensor in a low-sense mode to detect the person to activate the water control device, and operating the sensor in a high-sense mode to detect the person is nearby to the sensor without activating the water control device.

38. The method of claim 25, further comprising the step controlling the water cleansing mode of any one water control device based on the sensing of the sensor associated with any one other water control device.

39. The method of claim 25, further comprising the step of controlling the water cleansing mode of any one water control device based on the sensing of the sensor associated with any one other device in the water usage environment.

40. The method of claim 25, further comprising the steps of detecting, using a sensor, a credential associated with at least one authorised person, generating an authorisation signal based on the credential, and controlling the water cleansing mode based on the authorisation signal.

41. The method of claim 40, further comprising the step of modifying the water cleansing mode upon a determination that the authorised person has a credential that permits the water cleansing mode to be modified.

42. The method of claim 25, further comprising the steps of modifying the water cleansing mode by allowing the water cleansing mode to continue in the event the authorised person approaches and/or enters the water usage environment.

43. The method of claim 25, whereupon activation of the water cleansing mode, the method further comprises the steps of deactivating the water cleansing mode upon a determination that at least one person is within, approaching and/or entering the water usage environment based on the sensing of the sensor.

44. The method of claim 43, wherein deactivating the water cleansing mode comprises one or more of: stopping hot water from flowing through the water control device and/or the pipework; stopping hot water from flowing in the water usage environment; diverting hot water flowing out of a water control device to an auxiliary water outlet; stopping a water control device from functioning; generating an audible or visible indication that a water control device is not to be used; generating an indication that a water control device is out of service; causing cold water to flow through the water control device to cool the water control device down.
